(19) United States
(12) Patent Application Publication
(10) Pub. No.: US 2023/0121474 A1
(43) Pub. Date: Apr. 20, 2023

(54) STERILIZATION COMPOSITIONS AND METHODS FOR USING THEREOF

(71) Applicant: Save Foods Ltd., Tel Aviv (IL)

(72) Inventors: Neta MATIS, Hod Hasharon (IL); Dan SZTYBEL, Raanana (IL); Nimrod BEN YEHUDA, Kiryat Tivon (IL)

(73) Assignee: Save Foods Ltd., Tel Aviv (IL)

(21) Appl. No.: 17/908,624

(22) PCT Filed: Mar. 1, 2021
(86) PCT No.: PCT/IL2021/050229

§ 371 Date: Sep. 1, 2022

Related U.S. Application Data
(60) Provisional application No. 62/983,691, filed on Mar. 1, 2020.

(51) Int. Cl. A01N 37/02; A01N 59/00; A01N 25/22; A01P 1/00

(52) U.S. Cl. CPC A01N 37/02; A01N 59/00; A01N 25/22; A01P 1/00

(57) ABSTRACT

The present invention is related to sanitizing compositions, kits and to methods for using thereof such as for reducing pathogen load on a substrate.

### CROSS REFERENCE TO RELATED APPLICATIONS

This application claims the benefit of priority under 35 U.S.C. § 119(e) of U.S. Provisional Patent Application No. 62/983,691, filed on Mar. 1, 2020, the contents of which are incorporated by reference as if fully set forth herein in their entirety.

### FIELD OF THE INVENTION

The invention relates generally to the field of compositions and methods for reducing pathogen load on a substrate.

### BACKGROUND OF THE INVENTION

Safe and reliable means of removing or preventing microorganisms from the surfaces and the environment of storage facilities is a growing public health and agricultural concern. Existing methods for removing or reducing pathogens in storage facilities do not adequately control microorganisms that have the potential to cause disease or spoilage. Accordingly, there is a large need for new methods and compositions that can greatly reduce or prevent the presence of microorganisms within storage facilities.

The foregoing examples of the related art and limitations related therewith are intended to be exemplary and illustrative, not limiting in scope. Other limitations of the related art will become apparent to those of skill in the art upon a reading of the following detailed description and a study of the figures.

### SUMMARY OF THE INVENTION

The following embodiments and aspects thereof are described and illustrated in conjunction with compositions systems, tools and methods which are meant to be exemplary and illustrative, not limiting in scope.

In one aspect of the invention, there is a sanitizing composition comprising an effective amount of (i) an oxidizing agent, of (ii) propionic acid, a salt thereof, or both, and of (iii) an acid component, the acid component comprises at least one of: an inorganic acid a salt thereof, or both; a C0-C10 carboxylic acid, a salt thereof, or both; and wherein the effective amount is so as to result in a w/w concentration of peroxypropionic acid within the composition of at least 10 ppm, and wherein a pH of the composition is between 0 and 5.5.

In one embodiment, the inorganic acid is selected from the group consisting of phosphorous acid, phosphoric acid, hydrochloric acid, sulfuric acid, nitric acid, a salt thereof, a cation exchanging resin or a combination thereof.

In one embodiment, a w/w concentration of the propionic acid, the salt thereof, or both within the sanitizing composition is at least 50 ppm.

In one embodiment, the effective amount comprises a total w/w concentration of (i) the propionic acid, the salt thereof, or both; and of (ii) the acid component within the sanitizing composition is between 250 and 4000 ppm.

In one embodiment, the oxidizing agent is selected from the group consisting of: a percarboxylic acid (PA), hydrogen peroxide, urea hydrogen peroxide, sodium peroxide, calcium peroxide, silver, silver salt and hydrogen peroxide (HP), sodium percarbonate, sodium periodate, sodium persulfate, ammonium persulfate, perchloric acid, sodium perborate, silver (II) oxide, chlorine dioxide, benzoyl peroxide, a ketone peroxide, a peroxydicarbonate, a peroxyester, a dialkyl peroxide, a hydroperoxide, and a peroxyketal or any combination or salt thereof.

In one embodiment, the C0-C10 carboxylic acid comprises a plurality of C0-C10 carboxylic acids.

In one embodiment, the C0-C10 carboxylic acid comprises a C1-C6 carboxylic acid.

In one embodiment, the C1-C6 carboxylic acid is selected from the group consisting of: lactic acid, citric acid, glycolic acid, butanoic acid, tartaric acid, and acetic acid, or any combination thereof.

In one embodiment, the sanitizing composition further comprises an agent selected from the group consisting of: a carrier gas, an aqueous solvent, a surfactant, an additive, and a stabilizer or any combination thereof.

In one embodiment, the surfactant is selected from the group consisting of: a non-ionic surfactant, an anionic surfactant, a cationic surfactant and an amphoteric surfactant or any combination thereof.

In one embodiment, the w/w concentration of: a) the surfactant and b) the stabilizer within the sanitizing composition is in a range from 0.1 to 10%.

In one embodiment, the additive comprises: a base, a pH regulator, an organic additive or any combination thereof.

In one embodiment, the oxidizing agent comprises HP, PA or both.

In one embodiment, the effective amount comprises a w/w concentration of the oxidizing agent of between 300 ppm and 1%.

In one embodiment, the sanitizing composition is stable for at least 48 h.

In another aspect, there is a method for reducing pathogen load, the method comprising: i) providing a substrate; and ii) contacting the substrate with an effective amount of the sanitizing composition of the invention under conditions sufficient for reducing pathogen load on or within the substrate.

In one embodiment, the substrate is selected for the group consisting of: an edible matter, a growth medium, a propagation medium, a harvesting surface, a container, a storage surface, a transport surface, a packaging surface, a treatment surface, and a processing surface or any combination thereof.

In one embodiment, contacting is selected from the group consisting of: spraying, submerging, dipping, and injecting or any combination thereof.

In one embodiment, contacting is for a time sufficient for reducing the pathogen load on or within the substrate.

In one embodiment, the method is for reducing colony forming units (CFU) on the substrate by a factor of 10 to 100,000, as compared to a non-treated substrate.

In one embodiment, the method is for preventing or inhibiting pathogen formation on the substrate within a time period of at least 5 days.

In one embodiment, the method is for reducing decay of the edible matter.

In another aspect, there is a method comprising i. providing a substrate treated by a sanitizing composition; ii. contacting the substrate with the sanitizing composition of the invention or with the kit of the invention; thereby prolonging an effect of the sanitizing composition.

In one embodiment, the substrate is selected for the group consisting of: an edible matter, a growth medium, a propagation medium, a harvesting surface, a container, a storage surface, a transport surface, a packaging surface, a treatment surface, and a processing surface or any combination thereof.

In one embodiment, prolonging is for a time period ranging from 1 to 30 days.

In another aspect, there is a kit comprising a first composition comprising (i) propionic acid, a salt thereof, or both, and (ii) an acid component, wherein the acid component comprises at least one of: an inorganic acid a salt thereof, or both; a C0-C10 carboxylic acid, a salt thereof, or both; and wherein a combined weight per weight (w/w) concentration of (i) and (ii) within the first component is between 20 and 90%.

In one embodiment, the kit further comprises a second component comprising an oxidizing agent.

In one embodiment, the oxidizing agent is selected from the group consisting of: a percarboxylic acid, hydrogen peroxide, urea hydrogen peroxide, sodium peroxide, calcium peroxide, silver, sodium percarbonate, sodium periodate, sodium persulfate, ammonium persulfate, perchloric acid, sodium perborate, silver (II) oxide, chlorine dioxide, benzoyl peroxide, a ketone peroxide, a peroxydicarbonate, a peroxyester, a dialkyl peroxide, a hydroperoxide, and a peroxyketal or any combination or salt thereof.

In one embodiment, a w/w concertation of the oxidizing agent within the second component is between 5 and 90%.

In one embodiment, the (i) propionic acid, the salt thereof, or both; and the (ii) acid component are present within the first component at a synergistically effective ratio between (ii) and (i) of at least 1:1 w/w.

In one embodiment, the acid component comprises citric acid, lactic acid or both.

In one embodiment, the first component, the second component, or both further comprise an agent selected from the group consisting of: a surfactant, an additive, a solvent, and a stabilizer or any combination thereof.

In one embodiment, the first component, the second component, or both is stable for at least 6 months.

In one embodiment, the kit further comprises instructions for mixing of the first component and of the second component at a predetermined ratio, thereby obtaining a sanitizing composition comprising a sanitizing effective amount of (i) the propionic acid, the salt thereof, or both; (ii) the acid component; and (iii) the oxidizing agent.

In one embodiment, the sanitizing effective amount comprises a w/w concertation of the propionic acid, a salt thereof, or both of between 50 ppm and 0.5%.

In one embodiment, the sanitizing effective amount comprises a w/w concertation of the oxidizing agent is between 10 and 1000 ppm.

In one embodiment, wherein any one of the first component and the second component is a liquid, and wherein the sanitizing composition is characterized by a pH of less than 5.

In addition to the exemplary aspects and embodiments described above, further aspects and embodiments will become apparent by study of the following detailed description.

### BRIEF DESCRIPTION OF THE FIGURES

FIG. 1 represents 13C-NMR spectrum of an exemplary composition comprising 20% w/w each of propionic acid, lactic acid and citric acid, 48 h after preparation of the composition. L.A. is lactic acid, C.A. is citric acid, and P.A. is propionic acid.

FIG. 2 represents 13C-NMR spectrum of an exemplary composition comprising 20% w/w each of propionic acid, lactic acid and citric acid; and 5% w/w of hydrogen peroxide, after 48h after preparation of the composition. A circle indicates formation of per-propionic acid.

FIG. 3 is a bar graph representing decay of mango treated by an exemplary composition of the invention (Composition A) as compared to treatment with peroxyacetic acid (PAA).

FIG. 4 is a bar graph representing decay of clementine treated by an exemplary composition of the invention (Composition B) as compared to treatment with peroxyacetic acid (PAA) and hot water.

### DETAILED DESCRIPTION OF THE INVENTION

The present invention, in some embodiments thereof, is directed to a composition comprising an effective amount of an oxidizing agent; of propionic acid, a salt thereof, or both; and of an acid component comprising at least one of: a) an inorganic acid; b) a C1-C10 carboxylic acid, a salt thereof, or both. In some embodiments, the composition of the invention (also used herein as “the sanitizing composition”) comprises an oxidizing agent; propionic acid and/or a salt thereof and at least one of citric acid and lactic acid including any salt thereof. In some embodiments, the effective amount of the oxidizing agent, of propionic acid, and of the acid component is so as to result in a sanitizing effective amount of peroxypropionic acid within the composition of the invention. In some embodiments, the effective amount is a synergistically effective amount. In some embodiments, a pH of the composition of the invention is less than 5.5.

The invention is further directed to a kit comprising (i) propionic acid, a salt thereof, or both, and (ii) the acid component. In some embodiments, the kit further comprises the oxidizing agent.

The invention is further directed to a method for manufacturing the sanitizing composition of the invention, comprising mixing the first compartment and the second compartment of the kit.

The invention is further directed to a method for reducing or preventing pathogen load on or within a substrate, comprising providing a substrate; and contacting the substrate with an effective amount of the composition or the kit of the invention under conditions sufficient for reducing or preventing pathogen load on or within the substrate. In some embodiments, the method is for preventing or reducing pathogen formation within a time period of at least 10 days. In some embodiments, the method is for preventing or reducing decay of the substrate (e.g. edible matter). In some embodiments, the decay is pathogen related decay. In some embodiments, preventing or reducing is by at least 10%, compared to a control (e.g. untreated composition).

The invention is further directed to a method for prolonging a sanitizing effect, comprising providing a substrate treated by a sanitizing composition; contacting the substrate with the first compartment of the kit, thereby prolonging the sanitizing effect for a time period ranging from 1 to 300 days.

### Composition

In one aspect of the invention provided herein there is a composition comprising an effective amount of an oxidizing agent; of propionic acid and/or a salt thereof, and of an acid component comprising at least one of: a) an inorganic acid a salt thereof, or both; b) a C1-C10 carboxylic acid, a salt thereof, or both. In some embodiments, the oxidizing agent and the acid component comprise food-acceptable compounds. In some embodiments, the effective amount of the oxidizing agent; of propionic acid and/or a salt thereof, and of the acid component is a food-acceptable amount (e.g in the diluted ready-to-use sanitizing composition). In some embodiments, the composition comprises an oxidizing agent; propionic acid, citric acid and lactic acid. In some embodiments, the composition comprises propionic acid and/or a salt thereof, citric acid and/or a salt thereof and lactic acid and/or a salt thereof. In some embodiments, the composition comprises propionic acid, citric acid and lactic acid, a salt thereof or both.

In some embodiments, the effective amount of the oxidizing agent; of propionic acid and/or a salt thereof, and of the acid component is so as to obtain an effective amount of a peroxycarboxylic acid (also used herein as the per-acid), such as peroxypropionic acid (also used herein as “per-propionic acid”), perlactic acid, and/or percitric acid, including any mixture or a derivative thereof. In some embodiments, the effective amount of the per-acid (e.g. peroxypropionic acid) within the composition of the invention is between 0.2 and 2%, between 0.2 and 0.5%, between 0.5 and 1%, between 0.7 and 1.5%, between 1 and 1.5%, between 1.5 and 2% by weight of the composition, including any range or value therebetween.

In some embodiments, the effective amount of the per-acid (e.g. peroxypropionic acid), as used herein, refers to a sanitizing effective amount within the sanitizing composition of the invention (e.g. diluted ready-to-use sanitizing composition). In some embodiments, the sanitizing effective amount of the per-acid (e.g. peroxypropionic acid) is sufficient for inducing or prolonging a sanitizing effect on or with a substrate, wherein the substrate is as described herein (e.g. edible matter). In some embodiments, the sanitizing effective amount of the per-acid is at least 10 ppm, at least 30 ppm, at least 50 ppm, at least 100 ppm, at least 150 ppm, at least 200 ppm, at least 300 ppm, including any range or value therebetween.

In some embodiments, the effective amount of the acid component within the composition is sufficient for resulting in a pH value of the composition being less than 5.5, less than 5.0, less than 4.8, less than 4.5, less than 4, less than 3, less than 2, less than 1, including any range or value therebetween. In some embodiments, the effective amount of the acid component within the composition of the invention is so, that upon dilution of the composition, a pH value of the resulting sanitizing composition is in a range of between 1 and 5.5, of between 1 and 2, of between 2 and 3, of between 3 and 4, of between 4 and 4.5, of between 4.5 and 5, including any range or value therebetween, and wherein dilution is as described hereinbelow.

In some embodiments, the effective amount of the oxidizing agent; of propionic acid and/or a salt thereof, and of the acid component is so that upon dilution of the composition of the invention up to 10 times, up to 100 times, up to 1000 times, up to 5000 times, the resulting diluted composition comprises an effective amount of peroxypropionic acid of at least 10 ppm, at least 30 ppm, at least 50 ppm, at least 100 ppm, at least 150 ppm, at least 200 ppm, at least 300 ppm, including any range or value therebetween.

In some embodiments, the effective amount of the acid component within the composition is sufficient for obtaining a composition characterized by a pH value below the pKa value of propionic acid. In some embodiments, the pH value of the composition of the invention is so as to protonate at least 30%, at least 50%, at least 60%, at least 70%, at least 80%, at least 90%, at least 95% by weight of the propionic acid, including any range or value therebetween. In some embodiments, the effective amount of the acid component within the composition is sufficient for catalyzing or inducing the formation of a per-acid from a corresponding carboxylic acid.

In some embodiments, the effective amount of the acid component within the composition is sufficient for obtaining a buffered solution, wherein the buffered solution has a pH value as described hereinabove.

In some embodiments, the effective amount comprises synergistically effective amount of the acid component and of the propionic acid, wherein the synergistically effective amount is sufficient for preventing or reducing pathogen load on the substrate, for a time period described herein. In some embodiments, the synergistically effective amount comprises a w/w ratio of the acid component to the propionic acid of between 1:1 and 5:1; between 1:1 and 1.2:1; between 1.2:1 and 1.5:1; between 1.5:1 and 2:1; between 2:1 and 2.5:1; between 2:1 and 3:1; between 3:1 and 5:1; including any range or value therebetween.

In some embodiments, the synergistically effective amount is so as to result in an efficient buffer capable of maintaining the pH of the composition at a range described herein, before and/or after contacting with the substrate. One skilled artisan will appreciate, that the exact ratio between the acid component to the propionic acid may vary, depending on the desired pH range and on the specific composition of the acid component.

In some embodiments, the composition comprises a solvent. In some embodiments, the solvent is sufficient for substantially dissolving the components of the composition. In some embodiments, the solvent is sufficient for dissolving the oxidizing agent; propionic acid, and the acid component. In some embodiments, the solvent is sufficient for forming a solution of the oxidizing agent, propionic acid and the acid component.

In some embodiments, the solvent is a water-miscible solvent. In some embodiments, the solvent is a polar organic solvent.

In some embodiments, the solvent is an aqueous solvent. In some embodiments, the aqueous solvent comprises water and optionally a salt (e.g. a buffering agent).

Non-limiting examples of polar organic solvents contain but are not limited to: ethanol, methanol, propanol, butanol, pentanol, acetone, isopropanol, or any combination thereof.

In some embodiments, the composition of the invention is substantially devoid of an alcohol (e.g. C2-C10 alcohol such as ethanol, propanol, butanol, pentanol, etc.).

In some embodiments, the composition is a liquid composition. In some embodiments, the composition is a liquid at a temperature between 0 and 95° C. In some embodiments, the composition is an aqueous composition, comprising: 1) the oxidizing agent, 2) propionic acid; 3) the acid component, and 4) an aqueous solvent. In some embodiments, the composition is an aqueous composition, comprising: 1) the oxidizing agent, 2) propionic acid; 3) the acid component, 4) an aqueous solvent and 5) a surfactant.

In some embodiments, the composition is an aqueous composition having at least 10%, 20%, 30%, 40%, 50%, 60%, 70%, 80%, 90%, 95%, 98% or 99% water by weight.

In some embodiments, the oxidizing agent is any of: a peroxide, a peroxide source or both. In some embodiments, the oxidizing agent is peroxycarboxylic acid.

In some embodiments, the oxidizing agent is selected from the group consisting of: hydrogen peroxide, urea hydrogen peroxide, silver, metal peroxide (such as sodium peroxide, calcium peroxide) and/or a derivative thereof, a percarbonate salt (such as sodium percarbonate, calcium percarbonate) and/or a derivative thereof, a periodate salt (such as sodium periodate) and/or a derivative thereof, a persulfate salt (such as sodium persulfate, ammonium persulfate) and/or a derivative thereof, a perborate salt (such as sodium perborate) and/or a derivative thereof, silver (II) oxide, perbenzoic acid and/or a derivative thereof (such as a chloro-perbenzoic acid, or a salt thereof), perchloric acid or a salt thereof, chlorine dioxide, benzoyl peroxide, a ketone peroxide, a peroxydicarbonate, a peroxyester, a dialkyl peroxide, a peroxyacetic acid (PAA), a hydroperoxide, a peroxyketal or any combination thereof. In some embodiments, the oxidizing agent comprises a silver salt and hydrogen peroxide.

In some embodiments, the derivative, as used herein is referred to a structural isomer and/or to a chemical derivative of any of the herein disclosed acids and/or oxidizing agents. In some embodiments, the derivative is a biologically active derivative having an anti-microbial or anti-pathogenic activity.

In some embodiments, the oxidizing agent is selected from the group consisting of: hydrogen peroxide, urea hydrogen peroxide, sodium peroxide, calcium peroxide, sodium percarbonate, sodium periodate, sodium persulfate, ammonium persulfate, sodium perborate, silver (II) oxide, chlorine dioxide, benzoyl peroxide, a ketone peroxide, a peroxydicarbonate, a peroxyester, a dialkyl peroxide, a hydroperoxide, a peroxyketal or any combination thereof.

In some embodiments, the percarboxylic acids is a food-acceptable percarboxylic acid. Such percarboxylic acids are well-known in the art. Non-limiting examples of percarboxylic acids include but are not limited to: peracetic acid (PAA), peroctanoic acid, perlactic acid, perpropionic acid, percitric acid, and persalicylic acid, performic acid, including any mixture or a derivative thereof.

In some embodiments, the oxidizing agent is any of: hydrogen peroxide, a source of hydrogen peroxide, peroxycarboxylic acid (such as PAA) or a combination thereof. In some embodiments, the oxidizing agent is hydrogen peroxide.

In some embodiments, the composition comprises propionic acid, a food-acceptable propionic acid salt, or both.

In some embodiments, the acid component comprises an inorganic acid. In some embodiments, the inorganic acid is a strong acid being capable of inducing formation of per-propionic acid. Without being bound to any theory or mechanism, a strong inorganic acid may react with the oxidizing agent (such as H2O2) so as to induce or catalyze formation of per-propionic acid, perlactic acid, and/or percitric acid, including any mixture or a derivative thereof.

In some embodiments, the inorganic acid is a food-acceptable acid and/or a food-a food-acceptable salt thereof. Such food-acceptable acid are well-known in the art. In some embodiments, the inorganic acid comprises a single acid. In some embodiments, the inorganic acid comprises a plurality of acids. In some embodiments, the inorganic acid comprises a mixture of acids. In some embodiments, the inorganic acid is selected from the group consisting of phosphorous acid, phosphoric acid, hydrochloric acid, sulfuric acid, nitric acid, including a salt, a derivative or any combination thereof. In some embodiments, the inorganic acid is in a form of a proton releasing polymer or a cation exchange resin (e.g. Dowex 50Wx2, Smopex-101, Dowex 50Wx8, Amberlite IR-120, Amberlyst 15)

In some embodiments, the C0-C10 carboxylic acid is represented by Formula: R—COOH, wherein R is or comprises a hydrogen, or a C1-C10 alkyl. In some embodiments, the acid component comprises formic acid. In some embodiments, the acid component comprises a C1-C10 carboxylic acid, a salt thereof, or both. In some embodiments, the acid component comprises a food-acceptable C1-C10 carboxylic acid. In some embodiments, the acid component comprises a plurality of C1-C10 carboxylic acids. In some embodiments, the acid component comprises from 2 to 5, from 2 to 4, from 2 to 3, C1-C10 carboxylic acids. In some embodiments, the acid component or the composition is substantially devoid of acetic acid.

In some embodiments, the C1-C10 carboxylic acid is or comprises a food grade acid. In some embodiments, the C1-C10 carboxylic acid is or comprises a food-acceptable acid and/or a food-acceptable salt thereof. Food acceptable carboxylic acids are well-known in the art (e.g. propionic acid, benzoic acid, citric acid, lactic acid, etc.) In some embodiments, the C1-C10 carboxylic acid is represented by Formula: R—COOH, or by Formula: HOOC—R—COOH, wherein R is or comprises a C1-C10 alkyl. In some embodiments, the salt of C1-C10 carboxylic acid is represented by Formula: R—COO⁻X⁺, wherein R is or comprises a C1-C10 alkyl, and X is a counterion as described herein (e.g. a monovalent or a divalent metal cation, such as Na, K, Li, Ca, Mg etc.).

In some embodiments, the C1-C10 carboxylic acid is or comprises a mono-carboxylc acid (comprising one carboxy group, and represented by Formula: R—COOH). In some embodiments, the C1-C10 carboxylic acid comprises a di-, and/or a tri-carboxylic acid (comprising 2 or 3 carboxy groups respectively).

In some embodiments, the C1-C10 carboxylic acid is a C1-C10 alkyl carboxylic acid. In some embodiments, the C1-C10 alkyl is selected from a primary alkyl, a secondary alkyl, and a tertiary alkyl. In some embodiments, the alkyl is an alkenyl. In some embodiments, the alkyl is a substituted alkyl. In some embodiments, the alkyl is selected from a linear alkyl and a branched alkyl. In some embodiments, the substituted alkyl comprises one or more substituents. In some embodiments, the substituent comprises any of a hydroxy group, a halo group, an alkyl group, a carboxy group, an amide group, a carbonyl group, an anhydride, a carbonate ester, a carbamate, a cyano group, an amino group, a mercapto group including any combination thereof.

In some embodiments, the C1-C10 alkyl comprises any of C1-C2 alkyl, C2-C10 alkyl, C2-C10 alkyl, C2-C4 alkyl, C4-C6 alkyl, C6-C8 alkyl, C8-C10 alkyl, including any range and/or any combination thereof.

In some embodiments, the C1-C10 carboxylic acid is a fruit acid. In some embodiments, the C1-C10 carboxylic acid is 2-hydroxy carboxylic acid. In some embodiments, the C1-C10 carboxylic acid is C1-C6 carboxylic acid. In some embodiments, the C1-C6 carboxylic acid is represented by Formula: R—COOH, or by Formula: HOOC—R—COOH, wherein R is or comprises a C1-C6 alkyl. In some embodiments, the C1-C6 alkyl comprises any of C1-C2 alkyl, C2-C6 alkyl, C1-C6 alkyl, C2-C4 alkyl, C4-C6 alkyl, including any range and/or any combination thereof. In some embodiments, the C1-C6 alkyl is selected from a primary alkyl, a secondary alkyl, and a tertiary alkyl. In some embodiments, the alkyl is an alkenyl. In some embodiments, the alkyl is a substituted alkyl. In some embodiments, the alkyl is selected from a linear alkyl and a branched alkyl. In some embodiments, the substituted alkyl comprises one or more substituents. In some embodiments, the substituent comprises any of a hydroxy group, a halo group, an alkyl group, a carboxy group, an amide group, a carbonyl group, an anhydride, a carbonate ester, a carbamate, a cyano group, an amino group, a mercapto group including any combination thereof.

In some embodiments, the C1-C6 carboxylic acid is 2-hydroxy C1-C6 carboxylic acid. In some embodiments, the C1-C10 carboxylic acid comprises an aromatic carboxylic acid comprising an optionally substituted (e.g. by any of a hydroxy group, a halo group, an alkyl group, a carboxy group, an amide group, a carbonyl group, an anhydride, a carbonate ester, a carbamate, a cyano group, an amino group, a mercapto group, including any combination thereof) phenyl carboxylic acid.

Non-limiting examples of C1-C6 2-hydroxy carboxylic acids contain but are not limited to: tartaric acid, citric acid, malic acid, mandelic acid, salicylic acid, ascorbic acid and lactic acid, or any combination thereof.

In some embodiments, the C1-C6 carboxylic acid comprises at least two carboxylic acids selected from the group consisting of: tartaric acid, glycolic acid, butanoic acid, pyruvic acid, citric acid, malic acid, mandelic acid, sorbic acid, benzoic acid, adipic acid and lactic acid, or any combination thereof.

In some embodiments, the C1-C6 carboxylic acid is selected from the group consisting of: lactic acid, citric acid, or both. In some embodiments, the acid component comprises lactic acid, and citric acid.

In some embodiments, the composition of the invention comprises an effective amount of: hydrogen peroxide, of propionic acid, of lactic acid, and of citric acid. In some embodiments, the composition of the invention comprises an effective amount of a peracid (e.g. PAA), of propionic acid, of lactic acid, and of citric acid.

In some embodiments, the oxidizing agent (e.g. hydrogen peroxide, or a peracid such as PAA), propionic acid, citric acid and optionally lactic acid compose between 50 and 99.9%, between 50 and 70%, between 70 and 80%, between 80 and 90%, between 90 and 95%, between 95 and 99.9%, by weight of the active ingredients of the composition of the invention, including any range or value therebetween.

In some embodiments, the active ingredients of the composition refer to any compound required for obtaining a synergistic antimicrobial effect, as described herein. In some embodiments, the active ingredients of the composition refer to any compound required for providing the sanitizing effect (e.g. antimicrobial effect).

In some embodiments, the composition of the invention is or comprises a dilutable composition, wherein dilutable comprises dilution up to 10 times, up to 30 times, up to 50 times, up to 100 times, up to 500 times, up to 1000 times, up to 10000 times, including any range or value therebetween. In some embodiments, the composition of the invention is stable upon dilution by a dilution factor ranging between 2 and 10000, including any range or value therebetween.

As used herein the term “stable” is referred to the chemical stability and/or physical stability of the composition of the invention. In some embodiments, a composition is referred to as “stable” if it substantially retains its chemical composition upon storage under appropriate storage conditions. In some embodiments, a composition is referred to as “stable” if it substantially retains its physical appearance (e.g. state of matter) and is substantially devoid of phase separation, precipitation, aggregation, agglomeration or turbidity under appropriate storage conditions. In some embodiments, appropriate storage conditions comprise a temperature of between 1 and 60° C. In some embodiments, appropriate storage conditions comprise ambient atmosphere. In some embodiments, appropriate storage conditions comprise storage time of at least 1 month (m), at least 2 m, at least 3 m, at least 4 m, at least 5 m, at least 6 m, at least 7 m, at least 8 m, at least 10 m, at least 12 m, including any range or value therebetween. In some embodiments, the term “stable” refers to a storage stability of the composition, wherein storage stability comprises stability under appropriate storage conditions, as described herein.

In some embodiments, the composition described herein is related to a concentrate which is optionally diluted (e.g. prior to application), so as to obtain the above-mentioned concentration of any one of the active ingredients.

In some embodiments, the effective amount of the oxidizing agent comprises a weight per weight (w/w) concentration of the oxidizing agent within the composition of the invention (e.g. the concentrate) from 5 to 50%, from 5 to 10%, from 5 to 8%, from 7 to 9%, from 10 to 15%, from 15 to 20%, from 20 to 25%, from 25 to 30%, from 30 to 40%, from 40 to 50%, including any range or value therebetween. One skilled artisan will appreciate, that the exact concentration of the oxidizing agent within the composition may vary, depending on the strength of the oxidizing agent (as expressed by a standard oxidation potential thereof). For example, a per-acid (e.g. peracetic acid) has a greater oxidizing strength than hydrogen peroxide (HP), and is characterized by greater oxidation potential compared to HP. Accordingly, lower w/w concentration of the oxidizing agent is required, if peracetic acid is utilized as the oxidizing agent, as compared to a composition comprising HP as the oxidizing agent.

In some embodiments, the composition of the invention (e.g. the concentrate) comprises a per-acid as the oxidizing agent, wherein the w/w concentration of the per-acid is between 1 and 10%, between 0.5 and 10%, between 0.5 and 1%, between 1 and 3%, between 3 and 5%, between 5 and 10%, including any range or value therebetween.

In some embodiments, the effective amount of the acid component comprises a w/w concentration of the acid component within the composition of the invention (e.g. the concentrate) is from 5 to 30%, from 5 to 10%, from 10 to 15%, from 15 to 20%, from 20 to 25%, from 25 to 30%, from 30 to 90%, from 30 to 35%, from 35 to 40%, from 40 to 45%, from 45 to 50%, from 50 to 55%, from 55 to 60%, from 60 to 65%, from 65 to 70%, from 70 to 80%, from 80 to 90%, including any range therebetween.

In some embodiments, the effective amount of the acid component comprises a w/w concentration of the acid component within the composition of the invention (e.g. the concentrate) is less than 10%, less than 15%, less than 20%, less than 25%, less than 30%, less than 35%, less than 40%, less than 45%, less than 50%, less than 55%, less than 60%, less than 70%, less than 80%, less than 90%, including any value therebetween.

In some embodiments, the effective amount of propionic acid within the composition of the invention (e.g. the concentrate) comprises a w/w concentration of propionic acid ranging from 5 to 30%, from 5 to 10%, from 10 to 15%, from 15 to 20%, from 20 to 25%, from 25 to 30%, from 30 to 90%, from 30 to 35%, from 35 to 40%, from 40 to 45%, from 45 to 50%, from 50 to 55%, from 55 to 60%, from 60 to 65%, from 65 to 70%, from 70 to 80%, from 80 to 90%, including any range therebetween.

In some embodiments, a w/w ratio of propionic acid to the acid component within the composition of the invention (e.g. the concentrate or the sanitizing composition) is from 10:1 to 1:10, from 10:1 to 10:2, from 10:2 to 10:3, from 10:3 to 10:4, from 5:1 to 2:1, from 2:1 to 1:1, from 10:6 to 10:7, from 10:8 to 10:10, from 10:7 to 10:8, from 10:6 to 10:7, from 7:10 to 9:10, from 9:10 to 10:10, from 1:1 to 1:2, from 1:2 to 1:3, from 1:3 to 1:5, from 1:5 to 1:10, including any range therebetween.

In some embodiments, a molar ratio of propionic acid to the acid component within the composition of the invention (e.g. the concentrate or the sanitizing composition) is from 1:1 to 1:5, from 1:1 to 1:2, from 1:2 to 1:3, from 1:3 to 1:4, from 1:3 to 1:5, including any range therebetween.

In some embodiments, the acid component citric acid and lactic acid. In some embodiments, a w/w ratio of citric acid to lactic acid within the composition of the invention (e.g. the concentrate or the sanitizing composition) is from 10:1 to 1:10, from 10:1 to 10:2, from 10:2 to 10:3, from 10:3 to 10:4, from 10:4 to 10:5, from 10:5 to 10:6, from 10:6 to 10:7, from 10:8 to 10:10, from 10:7 to 10:8, from 10:6 to 10:7, from 1:10 to 2:10, from 2:10 to 3:10, from 3:10 to 4:10, from 4:10 to 5:10, from 5:10 to 7:10, from 7:10 to 9:10, from 9:10 to 10:10, including any range therebetween.

In some embodiments, a molar ratio of citric acid to lactic acid within the composition of the invention (e.g. the concentrate or the sanitizing composition) is from 5:1 to 1:5, from 5:1 to 3:1, from 3:1 to 2:1, from 2:1 to 1:1, from 1:1 to 1:2, from 1:2 to 1:3, from 1:3 to 1:5, including any range therebetween.

In some embodiments, the composition of the invention comprises propionic acid, and a mixture of citric acid and lactic acid as the acid component, wherein the w/w ratio between the propionic acid and the citric acid within the composition is from 10:8 to 10:10, from 10:7 to 10:8, from 10:6 to 10:7, from 10:6 to 10:5, from 5:10 to 7:10, from 7:10 to 9:10, from 9:10 to 10:10, including any range therebetween. In some embodiments, the w/w ratio between the propionic acid and the lactic acid within the composition is from 10:8 to 10:10, from 10:7 to 10:8, from 10:6 to 10:7, from 10:6 to 10:5, from 5:10 to 7:10, from 7:10 to 9:10, from 9:10 to 10:10, including any range therebetween.

In some embodiments, a w/w ratio of the oxidizing agent to the total acid content within the composition of the invention (e.g. the concentrate or the sanitizing composition) is from 5:1 to 1:20, from 5:1 to 5:2, from 5:2 to 5:3, from 5:3 to 4:1, from 4:1 to 3:1, from 3:1 to 1:1, from 1:1 to 1:2, from 1:2 to 1:3, from 1:3 to 1:4, from 1:4 to 1:5, from 1:5 to 1:7, from 1:7 to 1:10, from 1:10 to 1:15, from 1:15 to 1:20, from 1:20 to 1:30, including any range therebetween.

In some embodiments, a molar ratio of the oxidizing agent to the total acid content within the composition of the invention (e.g. the concentrate or the sanitizing composition) is from 5:1 to 1:5, from 5:1 to 5:2, from 5:2 to 5:3, from 5:3 to 4:1, from 4:1 to 3:1, from 3:1 to 1:1, from 1:1 to 1:2, from 1:2 to 1:3, from 1:3 to 1:4, from 1:4 to 1:5, including any range therebetween. In some embodiments, a total acid content is a sum of molar or weight contents of propionic acid and the acid component within the composition.

In some embodiments, a w/w ratio of the oxidizing agent to the propionic acid within the composition of the invention (e.g. the concentrate or the sanitizing composition) is from 10:1 to 1:10, from 10:1 to 10:2, from 10:2 to 10:3, from 10:3 to 10:4, from 10:4 to 10:5, from 10:5 to 10:6, from 10:6 to 10:7, from 10:8 to 10:10, from 10:7 to 10:8, from 10:6 to 10:7, from 1:10 to 2:10, from 2:10 to 3:10, from 3:10 to 4:10, from 4:10 to 5:10, from 5:10 to 7:10, from 7:10 to 9:10, from 9:10 to 10:10, including any range therebetween.

In some embodiments, the effective amount of the oxidizing agent and/or of the propionic acid within the composition of the invention comprises a w/w ratio between the oxidizing agent to the propionic acid being from 10:1 to 2:1, from 10:1 to 8:1, from 10:1 to 5:1, from 5:1 to 4:1, from 4:1 to 3:1, from 3:1 to 2:1, including any range therebetween.

In some embodiments, an effective amount comprises a w/w ratio between the oxidizing agent to the propionic acid being from 6:1 to 3:1, including any range therebetween, wherein the ratio is sufficient for obtaining an effective amount of the per-acid within the composition of the invention. In some embodiments, the composition of the invention (e.g. the concentrate) comprises a w/w ratio of HP to propionic acid of between 6:1 and 3:1, so as to result in an effective w/w concentration of per-propionic acid within the composition ranging from 0.5 to 5%, from 0.5 to 1%, from 1 to 2%, from 2 to 5%, including any range therebetween.

In some embodiments, there is sanitizing composition comprising an effective amount of (i) an oxidizing agent, of (ii) propionic acid, a salt thereof, or both, and of (iii) an acid component, the acid component comprises at least one of: an inorganic acid a salt thereof, or both; a C0-C10 carboxylic acid, a salt thereof, or both; wherein the effective amount is so as to result in a w/w concentration of peroxypropionic acid within the composition of at least 30 ppm, and wherein a pH of the composition is between 0 and 5.5. As used herein, the term sanitizing composition refers to a diluted (ready to use) antimicrobial composition comprising a sanitizing effective amount of any of the active ingredients (oxidizing agent, propionic acid and the acid component). In some embodiments, the sanitizing composition of the invention comprises synergistically effective amount of any of the active ingredients, as described herein. In some embodiments, the sanitizing composition comprises a food-acceptable concentration of any one of the active ingredients.

Without being bound to any particular theory, it is presumed that a mixture of propionic acid and the acid component as described herein, is characterized by superior sanitizing properties (comprising inter alia reduction of the pathogen load on or within the edible matter, and reduction of edible matter decay related to either pathogen load or to dehydration), over a composition solely comprising propionic acid or any one of citric acid and lactic acid and having the same total acid content.

In some embodiments, an effective amount comprises a w/w concentration of the oxidizing agent within the sanitizing composition is from 5 to 10,000 ppm, from 10 to 50 ppm, from 50 to 70 ppm, from 70 to 100 ppm, from 50 to 100 ppm, from 100 to 150 ppm, from 150 to 200 ppm, from 200 to 250 ppm, from 250 to 300 ppm, from 300 to 450 ppm, from 450 to 500 ppm, from 500 to 600 ppm, from 600 to 700 ppm, from 700 to 800 ppm, from 800 to 900 ppm, from 900 to 1000 ppm, from 1000 to 1500 ppm, from 1500 to 2000 ppm, from 2000 to 2500 ppm, from 2500 to 3000 ppm, from 3000 to 4000 ppm, from 4000 to 5000 ppm, from 5000 to 7000 ppm, from 7000 to 10,000 ppm, including any range or value therebetween. As described hereinabove, the exact concertation may vary depending on the oxidizing strength of the oxidizing agent.

In some embodiments, an effective amount comprises a concentration of the oxidizing agent sufficient to result in a formation of percarboxylic acid (e.g. per-propionic acid, per-lactic acid, per-citric acid, and/or per-acetic acid) at a sanitizing effective amount within the sanitizing composition, wherein the sanitizing effective amount ranges from 5 to 10,000 ppm, from 10 to 50 ppm, from 50 to 70 ppm, from 70 to 100 ppm, from 50 to 100 ppm, from 100 to 150 ppm, from 150 to 200 ppm, from 200 to 250 ppm, from 250 to 300 ppm, from 300 to 450 ppm, from 450 to 500 ppm, from 500 to 600 ppm, from 600 to 700 ppm, from 700 to 800 ppm, from 800 to 900 ppm, from 900 to 1000 ppm, from 1000 to 1500 ppm, from 1500 to 2000 ppm, from 2000 to 2500 ppm, from 2500 to 3000 ppm, from 3000 to 4000 ppm, from 4000 to 5000 ppm, from 5000 to 7000 ppm, from 7000 to 10,000 ppm, including any range or value therebetween. In some embodiments, the percarboxylic acid comprises at least two, at least three percarboxylic acids, as described herein.

In some embodiments, a sanitizing effective amount of hydrogen peroxide within the sanitizing composition is at least 50 ppm, at least 100 ppm, at least 150 ppm, at least 200 ppm, at least 250 ppm, at least 300 ppm, at least 350 ppm, at least 400 ppm, at least 450 ppm, at least 500 ppm, at least 550 ppm, at least 600 ppm, at least 650 ppm, at least 700 ppm, at least 800 ppm, at least 1000 ppm, at least 1500 ppm, at least 2000 ppm, at least 3000 ppm, including any range or value therebetween.

In some embodiments, a concentration of the oxidizing agent is sufficient to result in a formation of perpropionic acid at a w/w concentration within the composition being from 10 to 2000 ppm, from 10 to 50 ppm, from 20 to 50 ppm, from 50 to 70 ppm, from 70 to 100 ppm, from 50 to 100 ppm, from 100 to 150 ppm, from 150 to 200 ppm, from 200 to 250 ppm, from 250 to 300 ppm, from 300 to 450 ppm, from 450 to 500 ppm, from 500 to 600 ppm, from 600 to 700 ppm, from 700 to 800 ppm, from 800 to 900 ppm, from 900 to 1000 ppm, from 1000 to 1500 ppm, from 1500 to 2000 ppm from 50 to 70 ppm, from 70 to 100 ppm, from 50 to 100 ppm, from 100 to 150 ppm, from 150 to 200 ppm, from 200 to 250 ppm, from 250 to 300 ppm, from 300 to 450 ppm, from 450 to 500 ppm, from 500 to 600 ppm, from 600 to 700 ppm, from 700 to 800 ppm, from 800 to 900 ppm, from 900 to 1000 ppm, from 1000 to 1500 ppm, from 1500 to 2000 ppm including any range or value therebetween.

In some embodiments, a minimum effective concentration of hydrogen peroxide within the sanitizing composition is at least 500 ppm, at least 1000 ppm, including any range or value therebetween.

In some embodiments, the oxidizing agent is a percarboxylic acid (such as PAA) being at a w/w concentration within the sanitizing composition of at least 5 ppm, at least 20 ppm, at least 30 ppm, at least 40 ppm, at least 50 ppm, at least 60 ppm, at least 70 ppm, at least 80 ppm, at least 100 ppm, at least 150 ppm, at least 200 ppm, at least 250 ppm, at least 300 ppm, at least 350 ppm, at least 400 ppm, at least 450 ppm, at least 500 ppm, at least 550 ppm, at least 600 ppm, at least 650 ppm, at least 700 ppm, at least 800 ppm, at least 1000 ppm, at least 1500 ppm, at least 2000 ppm, at least 3000 ppm, including any range or value therebetween. In some embodiments, a minimum effective concentration of percarboxylic acid (such as PAA) within the sanitizing composition is between 30 and 300ppm, including any range or value therebetween.

In some embodiments, an effective amount of propionic acid within the sanitizing composition is from 5 to 10,000 ppm, from 10 to 30 ppm, from 30 to 50 ppm, from 50 to 70 ppm, from 70 to 100 ppm, from 50 to 100 ppm, from 100 to 150 ppm, from 150 to 200 ppm, from 200 to 250 ppm, from 250 to 300 ppm, from 300 to 450 ppm, from 450 to 500 ppm, from 500 to 600 ppm, from 600 to 700 ppm, from 700 to 800 ppm, from 800 to 900 ppm, from 900 to 1000 ppm, from 1000 to 1500 ppm, from 1500 to 2000 ppm, from 2000 to 2500 ppm, from 2500 to 3000 ppm, from 3000 to 4000 ppm, from 4000 to 5000 ppm, from 5000 to 7000 ppm, from 7000 to 10,000 ppm, including any range or value therebetween.

In some embodiments, a minimum effective concentration of propionic acid is at least 50 ppm, at least 100 ppm. In some embodiments, a minimum effective concentration of propionic acid is between 50 and 1500 ppm, including any range or value therebetween.

One skilled artisan will appreciate, that the effective amount of the oxidizing agent and of the propionic acid and/or the acid component within the sanitizing composition of the invention may vary, depending on the pH value of the substrate. For example, acidic fruits (such as citrus fruits) require lower total amount of acids (propionic acid and/or the acid component), compared to less acidic fruits (such as mango), or to basic vegetables (e.g. peppers). Furthermore, the exact concertation of the oxidizing agent and of the propionic acid and/or the acid component within the sanitizing composition of the invention may vary, depending on the contact time of the sanitizing composition with the substrate. For example, 10 ppm of the oxidizing agent and 50 ppm or less of propionic acid is sufficient for reducing or eradicating pathogen load on or within the substrate, upon contacting the substrate with the sanitizing composition for a time period of about 30min. However, it should be appreciated, that for a standard contacting time of about 30 seconds, higher concentrations of the active ingredients are required (e.g. between 80 and 150 ppm of per-acid, or between 800 and 2000 ppm of HP, and 300-4000 ppm of propionic acid).

In some embodiments, an effective amount of the acid component within the sanitizing composition is from 100 to 10,000 ppm, from 50 to 100 ppm, from 100 to 150 ppm, from 150 to 200 ppm, from 200 to 250 ppm, from 250 to 300 ppm, from 300 to 450 ppm, from 450 to 500 ppm, from 500 to 600 ppm, from 600 to 700 ppm, from 700 to 800 ppm, from 800 to 900 ppm, from 900 to 1000 ppm, from 1000 to 1500 ppm, from 1500 to 2000 ppm, from 2000 to 2500 ppm, from 2500 to 3000 ppm, from 3000 to 4000 ppm, from 4000 to 5000 ppm, from 5000 to 7000 ppm, from 7000 to 10,000 ppm, including any range or value therebetween.

In some embodiments, a minimum effective amount of the total acid content within the sanitizing composition is between 200 and 4000 ppm, between 200 and 250 ppm, between 250 and 300 ppm, between 300 and 400 ppm, between 400 and 600 ppm, between 600 and 1000 ppm, between 1000 and 2000 ppm, between 2000 and 3000 ppm, between 3000 and 4000 ppm, including any range therebetween.

In some embodiments, a minimum effective amount of the total acid content within the sanitizing composition is between 200 and 4000 ppm, and a minimum effective amount of the oxidizing agent (such as per-acid) is between 30 and 300 ppm including any range therebetween.

In some embodiments, a minimum effective amount of the total acid content within the sanitizing composition is between 200 and 4000 ppm, including any range therebetween; and a minimum effective amount of the oxidizing agent (such as HP) is between 500 ppm and 1%, between 500 ppm and 1000%, between 1000 ppm and 1%, including any range therebetween.

In some embodiments, the sanitizing composition is characterized by a pH value less than the pKa value of the propionic acid. In some embodiments, the pH value of the sanitizing composition is from 0.01 to 0.05, from 0.05 to 0.1, from 0.1 to 0.5, from 0.5 to 1, from 1.0 to 1.5, from 1.5 to 2.0, from 2.0 to 2.5, from 2.5 to 3.5, 2.5 to 4.0, 2.7 to 3.5, 2.5 to 4.5, 3.0 to 4.0, 3.0 to 4.5, or from 3.5 to 4.5, or from 4.5 to 5.5 including any range therebetween. In some embodiments, the ratio between the acid component and the propionic acid and/or the w/w concertation thereof within the sanitizing composition, is sufficient for reducing or maintaining the pH value at a range below the pKa value of the propionic acid. In some embodiments, the ratio between the acid component and the propionic acid and/or the w/w concertation thereof within the sanitizing composition is predetermined by the pH value of the substrate surface (e.g. acidic fruits or vegetable such as citrus fruits and peppers require lower total acid content, compared to more basic fruits such as mango or avocado).

In some embodiments, the ratio between the acid component and the propionic acid and/or the w/w concertation thereof within the sanitizing composition, is so that upon contact of the sanitizing composition with the substrate surface, a substantial amount (e.g. between 50 and 95% including any range between) of the propionic acid is in a protonated form.

In some embodiments, a w/w concentration of the acid component and the oxidizing agent within the composition is sufficient to generate an effective amount of a sanitizing agent. In some embodiments, the sanitizing gent is for reducing pathogen load on a surface or within a container. In some embodiments, the sanitizing agent is antimicrobial agent. In some embodiments, the sanitizing agent is a bactericidal agent. In some embodiments, the agent is a fungicidal agent. In some embodiments, the pathogen or microbe comprises a microorganism. In some embodiments, the pathogen or microbe comprises fungi, bacteria or both.

In some embodiments, the oxidizing agent is capable of at least partially oxidizing the propionic acid, and/or the acid component. Without being limited to any particular theory or mechanism, the acid component may react with the oxidizing agent so as to form a peroxyacid (also used herein as per-acid). Various peroxyacids are known in the art, and some of them (e.g. peroxyacetic acid) are potent anti-microbials with an oxidation potential greater than the oxidation potential of hydrogen peroxide.

In some embodiments, the sanitizing agent is a peroxyacid, wherein the peroxyacid comprises any of peroxypropionic acid, perlactic acid, and/or percitric acid or a combinationthereof. In some embodiments, the sanitizing composition agent is or comprises PAA.

In some embodiments, the composition as described herein, optionally comprises a catalyst. The catalyst may be present in the composition, to accelerate the reaction rate of the acid component with the oxidizing agent, thereby enhancing the formation of a peroxyacid. Typical catalysts are strong acids, such as, sulfuric acid, sulfonic acid, cation exchange resins, and phosphoric acid.

In some embodiments, the composition is referred as stable, if the concentration of a peroxyacid within the composition decreases by not more than 1% over 6 months at a temperature below 20° C.

In some embodiments, any of the compositions disclosed herein further comprises a carrier. In some embodiments, any of the compositions disclosed herein further comprises a food-acceptable carrier. In some embodiments, the carrier comprises a carrier gas, an aqueous solvent, a surfactant, an additive, and a stabilizer or any combination thereof.

In some embodiments, any of the compositions disclosed herein further comprises a surfactant. In some embodiments, the surfactant is selected from the group consisting of: a non-ionic surfactant, an anionic surfactant, a cationic surfactant and an amphoteric surfactant or any combination thereof.

Non-limiting examples of anionic surfactants include but are not limited to: (C₆—C₈) alkyl-sulfate and/or sulfonate (e.g., sodium or potassium lauryl sulfate, sodium or potassium dodecyl sulfate), fatty alcohol ether sulfate salt (e.g., (C₁₂—C₁₄)alkyl-O—(CH₂CH₂O)₂—SO₃⁻, ZOHARPON ETA 27), polyacrylate (e.g., sodium or potassium polyacrylates), or any combination thereof.

Non-limiting examples of non-ionic surfactants include but are not limited to: alkyl-polyglycoside (e.g., Triton CG 110, APG 810), polyethyleneglycol-(C₁₁—C₁₅)alkyl-ether (such as Imbentin AGS/35), alkoxylated fatty alcohol (such as Plurafac LF221), or any combination thereof.

In some embodiments, the surfactant is selected from the group consisting of: Plurafac LF221, a polyacrylate, Triton CG 110, APG 810, ZOHARPON ETA 27, Imbentin AGS/35, Plurafac LF221, Disponil or any combination thereof.

In some embodiments, the composition of the invention further comprises a stabilizer. As used herein, the term “stabilizer” refers to any compound which prevents a decomposition of an oxidizing agent (e.g. hydrogen peroxide) within the composition of the invention. Non-limiting examples of stabilizers include but are not limited to: a phosphonate, (such as etidronic acid, diethylenetriamine penta(methylene phosphonic acid)), a salt of a phosphonate, a silver salt or any combination thereof.

In some embodiments, the composition of the invention further comprises an additive. In some embodiments, the additive is selected from the group consisting of: an organic additive (e.g., a scent or an odorant, a colorant, a pigment, an anti-freeze agent), an anti-foaming agent, an inorganic salt, an acid, a base, and a buffering agent or any combination thereof.

In some embodiments, a w/w concentration of an additive within the composition is from 0.1 to 10%, from 0.1 to 5%, from 0.1 to 3%, from 0.1 to 2%, from 0.1 to 1%, including any range therebetween.

In some embodiments, a w/w concentration of the stabilizer within the composition is from 0.05% to 10%, from 0.1 to 10%, from 0.1 to 5%, from 0.1 to 3%, from 0.1 to 2%, from 0.1 to 1%, including any range therebetween.

In some embodiments, a w/w concentration of the surfactant within the composition is from 0.1 to 10%, from 0.1 to 5%, from 0.1 to 3%, from 0.1 to 2%, from 0.1 to 1%, including any range therebetween.

In some embodiments, the composition of the invention is in form of spray (e.g. an aerosol spray), and/or a fogger that creates fine micro droplets from 0.1 to 10 micron further comprising a carrier gas. In some embodiments, the composition of the invention is formulated for spray application, and comprises from 0.1 to 10% w/w of a surfactant, wherein the surfactant is as described herein.

Non-limiting examples of carrier gas include but are not limited to: hydrogen, nitrogen, helium, argon or carbon dioxide, or any combination thereof.

The sanitizing compositions of the present invention can be in a variety of forms including aqueous solutions, suspensions, gels, foams, fogs, and sprays. The disinfectant or sanitizing compositions can also be used as disinfectant fogs and disinfectant mists.

The compositions disclosed herein can be manufactured as dilute ready-to-use compositions, or as concentrates that can be diluted prior to use. The various compositions may also include fragrances, depending on the nature of the product.

In some embodiments, the sanitizing composition of the present invention can be formulated into a disinfectant foam or foaming composition. The disinfectant foams or foaming compositions include the sanitizing composition of the invention and foaming agents. Any foaming agent known in the art can be used depending on the desired application and characteristics of the resulting disinfectant foam.

In some embodiments, the sanitizing composition of the present invention can be in the form of a disinfectant aerosol or a fog. In some embodiments, the sanitizing composition of the present invention is formulated for dip coating application, and is substantially devoid of a surfactant.

In some embodiments, the composition of the invention is stable at a temperature between 20 and 60° C. for at least 24 h, at least 12 h, at least 48 h, at least 72 h, at least 4 days (d), at least 5 d, at least 7 d, at least 10 d, at least 15 d, at least 18 d, at least 20 d, at least 30 d, at least 45 d, at least 60 d, including any range or value therebetween. In some embodiments, the composition is stable at a temperature of less than 20° C. for at least 6 months, at least 12 months, including any range or value therebetween.

In some embodiments, any of the compositions disclosed herein further comprises between 10 ppm and 5% of acetic acid. In some embodiments, any of the compositions disclosed herein is substantially devoid of added acetic acid. In some embodiments, the composition of the invention comprises lactic acid, wherein up to 10%, up to 5%, up to 1% by weight of the lactic acid decomposes into acetic acid. In some embodiments, any of the compositions disclosed herein is substantially devoid of a keto-carboxylic acid (e.g. pyruvic acid, a-keto butyric acid, a-keto valeric acid). In some embodiments, any of the compositions disclosed herein is substantially devoid of an alcohol, such as ethanol or higher alcohols. In some embodiments, any of the compositions disclosed herein is substantially devoid of an amine oxide.

### Kit

In another aspect, the present invention provides a kit for combined preparations. In one embodiment, a “combined preparation” defines especially a “kit of parts” in the sense that the combination partners as described herein can be dosed independently or by use of different fixed combinations with distinguished amounts of the combination partners i.e., simultaneously, concurrently, separately or sequentially. In some embodiments, the parts of the kit of parts can then, e.g., be used simultaneously or chronologically staggered, that is at different time points and with equal or different time intervals for any part of the kit of parts. The ratio of the total amounts of the combination partners, in some embodiments, can be used in the combined preparation.

In another aspect of the invention, there is a kit comprising a first composition comprising (i) propionic acid, a salt thereof, or both, and (ii) an acid component, wherein the acid component is as described hereinabove. In some embodiments, the kit comprises a first composition comprising (i) propionic acid, a salt thereof, or both, and (ii) an acid component, wherein the acid component comprises at least one of: an inorganic acid a salt thereof, or both; a C0-C10 carboxylic acid, a salt thereof, or both; and wherein a combined w/w concentration of (i) and (ii) (also referred to as the total acid content) within the first composition is between 20 and 90%, between 20 and 30%, between 30 and 50%, between 50 and 55%, between 55 and 60%, between 60 and 65%, between 65 and 70%, between 70 and 90%, including any range or value therebetween. In some embodiments, the acid component and the ratios between the acid component and the propionic acid are as described herein.

In some embodiments, a w/w ratio between the propionic acid, the salt thereof, or both; and the acid component within kit at a synergistically effective ratio. In some embodiments, the synergistically effective ratio between the propionic acid, the salt thereof, or both; and the acid component is at least 1:1, at least 1.5:1, at least 2:1, at least 3:1 w/w including any range or value therebetween. In some embodiments, the synergistically effective ratio between the propionic acid, the salt thereof, or both; and the acid component is so as to obtain a solution characterized by a pH value lower than the pKa value of the propionic acid, as described hereinabove.

In some embodiments, the acid component comprises citric acid, lactic acid or both. In some embodiments, the synergistically effective ratio between the propionic acid and any of citric acid, and lactic acid is between 1:1 and 1:3, between 0.8:1 and 1:1, between 1:1 and 1:2, between 1:2 and 1:3, including any range or value therebetween.

In some embodiments, the first component is a liquid composition. In some embodiments, the first component is stable for a time period of at least at least 1 month, at least 6 month, at least 1 year, at least 2 years, including any range or value therebetween. In some embodiments, the first component is stable under storage conditions, as described herein.

In some embodiments, the first component is referred to as stable, if it retains at least 90%, at least 95% including any range between, of the initial total acid content for a time period described herein. In some embodiments, the first component comprising lactic acid is referred to as stable, if retains at least 70%, at least 80% including any range between, of the initial concertation of the lactic acid, wherein retaining is for a time period described herein. The first component of the kit comprising about 20% w/w of each propionic acid, lactic acid and citric acid, has been analyzed about 10 months after manufacturing. The results highlight the long stability of the acids mix and that the only by-product related to partial decomposition of the lactic acids into acetic acid (about 20% of the initial lactic acid concertation).

In some embodiments, the kit comprises a second component comprising an oxidizing agent, wherein the oxidizing agent is as described hereinabove. In some embodiments, a w/w concertation of the oxidizing agent within the second component is between 5 and 90%, between 5 and 10%, between 10 and 20%, between 20 and 30%, between 30 and 50%, between 50 and 90%, including any range or value therebetween.

In some embodiments, the first component and the second component of the kit are liquid compositions. In some embodiments, the first composition and/or the second composition of the kit comprises an aqueous solvent.

In some embodiments, the first component, the second component or both further comprises an additive or a carrier, as described herein.

In some embodiments, a w/w ratio of the first component to the second component is so as to result in an effective amount of the sanitizing agent upon mixing of the first component and the second component, wherein effective amount is as described herein. In some embodiments, a w/w ratio of the first component to the second component is so that upon mixing of the first component and the second component, the resulting sanitizing composition comprises a sanitizing effective amount of the sanitizing agent, wherein sanitizing effective amount is as described herein.

In some embodiments, the kit comprises instructions for mixing the first composition and the second composition of the kit so as to obtain the sanitizing composition of the invention. In some embodiments, the kit comprises instructions for mixing of the first component and of the second component at a predetermined ratio, and optionally further diluting the mixture, so as to obtain the sanitizing composition of the invention. In some embodiments, the predetermined ratio is so as to result in an effective amount of the sainting agent within the sanitizing composition, as described herein. In some embodiments, the predetermined ratio is so as to obtain a sanitizing composition comprising a minimum effective w/w concertation of the propionic acid, a salt thereof, or both of between 50 ppm and 0.5%, between 100 ppm and 0.5%, between 100 ppm and 4000 ppm, including any range between. In some embodiments, the predetermined ratio is so as to obtain a sanitizing composition comprising a minimum effective w/w concertation of the oxidizing agent is between 10 and 1000 ppm, between 30 and 300 ppm, between 500 and 1000 ppm, including any range between.

In some embodiments, the second component comprises HP. In some embodiments, the second component comprises a per-acid. In some embodiments, the second component comprises a source of a per-acid, wherein the per-acid is as described herein. In some embodiments, the source of a per-acid comprises HP and a corresponding acid (e.g. acetic acid), wherein HP and a corresponding acid are stored in separate containers and are mixed prior to use. In some embodiments, the source of a per-acid comprises means for generating the per-acid in-situ.

In some embodiments, the second component comprises a per-acid or a source thereof, wherein a ratio between the first component and the second component is so, that upon mixing of the first component and the second component and optionally further diluting the mixture with an aqueous solution, the resulting sanitizing composition comprises a sanitizing effective amount of (i) the propionic acid, and of the acid component; and (ii) of the per-acid, wherein the sanitizing effective amount is as described herein (e.g. w/w concertation of the per-acid of between 30 and 300 ppm).

In some embodiments, the second component is stable for at least at least 1 month, at least 6 month, at least 1 year, at least 2 years, including any range or value therebetween. In some embodiments, the first component is stable under storage conditions, as described herein.

In some embodiments, the second component is referred to as stable, if it retains at least 90%, at least 95% including any range between, of the initial concentration of the oxidizing agent for a time period described herein.

In some embodiments, the first composition and the second components of the kit are mixed together up to 30d h before use of the sanitizing composition as described herein. In some embodiments, the first component and the second component of the kit are mixed together for at least 10 seconds, at least 1 hour (h), at least 10 h, at least 24 h, at least 48 h before use (e.g. application to the substrate), including any range between. In some embodiments, mixing is as described hereinbelow.

In some embodiments, the first composition of the kit and the second composition of the kit are mixed together up to 48 h before use of the composition. In some embodiments, the first composition of the kit and the second composition of the kit are mixed together up to 72 h before use of the composition. In some embodiments, mixing comprises dosing the first composition and the second composition in an amount sufficient for obtaining a predetermined molar ratio of hydrogen peroxide to a total acid content within the composition. In some embodiments, predetermined ratio of hydrogen peroxide to the total acid content is between 1:1 to 1:10, between 1:1 to 1:2, between 1:2 to 1:3, between 1:3 to 1:4, between 1:4 to 1:5, between 1:5 to 1:7, between 1:5 to 1:10, including any range or value therebetween.

In some embodiments, dosing comprises dispensing a predetermined amount of the first composition and a predetermined amount of the second composition and subsequent mixing thereof, so as to obtain a predetermined concentration of an active agent within the composition, wherein the active agent is as described hereinabove. In some embodiments, dosing is by inducing homogenous dilution of the mixture. In some embodiments, dosing is by continuous injection of any one of the components of the composition within the delivery system. In some embodiments, dosing is by a metering pump. In some embodiments, dosing is by preventing or reducing air bubbles formation within the delivery system. In some embodiments, the delivery system comprises delivery pipeline (e.g. water pipe).

In some embodiments, the acid component, the total acid content and the oxidizing agent are as described hereinabove. In some embodiments, the oxidizing agent is formulated within the second composition and propionic acid and the acid component are formulated within the first composition.

In some embodiments, the first composition and the second composition of the kit further comprise a solvent, wherein the solvent is as described hereinabove. In some embodiments, the first composition and the second compositions are aqueous compositions.

In some embodiments, a w/w concentration of propionic acid within the first component is from 5 to 30%, from 5 to 10%, from 10 to 15%, from 15 to 20%, from 20 to 25%, from 25 to 30%, from 30 to 90%, from 30 to 35%, from 35 to 40%, from 40 to 45%, from 45 to 50%, from 50 to 55%, from 55 to 60%, from 60 to 65%, from 65 to 70%, from 70 to 80%, from 80 to 90%, including any range therebetween.

In some embodiments, at least one of the first component and the second component further comprises an agent selected from the group consisting of: a surfactant, an additive, and a stabilizer or any combination thereof, wherein the surfactant, the additive and the stabilizer are as described hereinabove.

In some embodiments, the first composition, the second composition, or both is stable for at least 6 months.

As used herein the term “stable” is referred to chemical stability of each of the components of the kit (such as the acids within the first composition and hydrogen peroxide within the second composition of the kit).

Without being bound to any particular theory or mechanism, upon mixing the first composition and the second composition of the kit, a plurality of peroxyacids are formed. As described hereinbelow a composition comprising a plurality of peroxyacids (such as the composition of the invention) is sufficiently less stable compared to a composition comprising a single peroxyacid. Therefore, in order to prolong its long-term stability, the composition is in a form of the kit, wherein each of the first composition and the second composition are stored separately. Each of the first composition and the second composition of the kit can be applied separately or as a mixture, such as in a form of the composition of the invention. In some embodiments, the first composition and the second composition of the kit are mixed together so as to result the composition of the invention. In some embodiments, the first composition and the second composition of the kit are mixed together up to 48 h before use of the composition. In some embodiments, the first composition and the second composition of the kit are mixed together for at least 10 s (e.g. if the second component comprises a per-acid). In some embodiments, the first composition and the second composition of the kit are mixed in-situ within the supply system.

### Substrate

In another aspect of the invention, there is an article comprising a substrate in contact with the kit or the composition of the invention. In some embodiments, a substrate is in contact with the first composition of the kit. In some embodiments, a substrate is in contact with a solid composition comprising propionic acid and the acid component, wherein the acid component is as described hereinabove.

In some embodiments, a w/w ratio of propionic acid to the acid component within the solid composition is from 15:1 to 1:15, from 10:1 to 1:10, from 10:1 to 10:2, from 10:2 to 10:3, from 10:3 to 10:4, from 10:4 to 10:5, from 10:5 to 10:6, from 10:6 to 10:7, from 10:8 to 10:10, from 10:7 to 10:8, from 10:6 to 10:7, from 1:10 to 2:10, from 2:10 to 3:10, from 3:10 to 4:10, from 4:10 to 5:10, from 5:10 to 7:10, from 7:10 to 9:10, from 9:10 to 10:10, including any range therebetween.

In some embodiments, the substrate (e.g. edible matter) is in contact with a solid composition comprising propionic acid, and at least one of citric acid and lactic acid, wherein the concertation of the propionic acid is at least 10 ppm, at least 20 ppm, at least 50 ppm, including any range between. In some embodiments, the substrate (e.g. edible matter) is in contact with a solid composition comprising propionic acid, citric acid and lactic acid, wherein the w/w ratio between the propionic acid to any of citric acid and lactic acid is between 0.5:1 to 1:0.5, including any range therebetween. In some embodiments, the substrate comprises residual amounts of propionic acid, and optionally residual amounts of lactic acid and/or citric acid. One skilled artisan will appreciate, that if the substrate comprise an edible matter having significant concertation of citric acid (such as citrus fruits), the amount of the citric acid within such substrate is substantially predetermined by the initial concertation of the citric acid.

In some embodiments, the solid composition further comprises a carrier selected from the group consisting of: a surfactant, an additive, and a stabilizer or any combination thereof, wherein the carrier is as described herein. In some embodiments, a w/w ratio of the carrier to the propionic acid is from 0.1 to 10%, from 0.1 to 5%, from 0.1 to 3%, from 0.1 to 2%, from 0.1 to 1%, including any range therebetween.

In some embodiments, a substrate is a solid substrate, wherein the substrate is as described hereinbelow. In some embodiments, a solid substrate is a porous substrate, being characterized by a high surface area. In some embodiments, the porous substrate is in a crystalline state, in an amorphous state or a combination thereof. In some embodiments, the porous substrate comprises a gel.

In some embodiments, the solid composition is physically or non-covalently bound to the substrate. In some embodiments, the solid composition is bound to an outer surface of the substrate. In some embodiments, the substrate is as described hereinbelow.

### Methods

In another aspect of the invention, there is a method for reducing pathogen load on a substrate. In some embodiments, the method comprises contacting a substrate with an effective amount of the sanitizing composition of the invention under conditions sufficient for reducing pathogen load on the substrate. In some embodiments, the effective amount comprises sanitizing effective amount, as described herein.

In some embodiments, the method is for reducing pathogen load on a substrate surface. In some embodiments, the method is for reducing pathogen load within the substrate. In some embodiments, the method is for preventing pathogen formation on or within the substrate.

In some embodiments, the method comprises providing a substrate; and contacting the substrate with an effective amount of the sanitizing composition of the inveniton or with an effective amount of the kit of the invention. In some embodiments, the method comprises providing a substrate; and contacting the substrate with an effective amount of the sanitizing composition of the invention comprising the oxidizer (e.g., hydrogen peroxide, or PAA), propionic acid, and the acid component (e.g., inorganic acid, or a combination of lactic acid and citric acid), as described herein. In some embodiments, contacting is under conditions sufficient for reducing pathogen load on or within the substrate. In some embodiments, the pathogen load is as described hereinbelow.

In some embodiments, conditions sufficient for reducing pathogen load comprise contacting time sufficient for reducing the pathogen load on the substrate. In some embodiments, contacting time is for at least 0.1 min, at least 0.1 min, at least 0.1 min, at least 0.1 min, at least 0.2 min, at least 0.3 min, at least 0.4 min, at least 0.5 min, at least 0.6 min, at least 0.7 min, at least 0.8 min, at least 0.9 min, at least 1 min, at least 2 min, at least 3 min, including any range or value therebetween. As described hereinabove, contacting time is predefined by the effective concertation of the active agents within the sanitizing composition of the invention, for example lower concertation requires longer contacting time and vice versa.

In some embodiments, contacting is at a temperature between 1 and 60° C., between 10 and 50° C., between 15 and 40° C., between 10 and 30° C., between 20 and 60° C., between 20 and 30° C., between 20 and 40° C., including any range or value therebetween.

In some embodiments, contacting is at a temperature between 10 and 90° C., between 10 and 50° C., between 50 and 90° C., between 50 and 60° C., between 60 and 70° C., between 70 and 80° C., between 80 and 90° C., including any range or value therebetween.

In some embodiments, contacting at a temperature between 50 and 90° C. results in an increased anti-pathogen activity. In some embodiments, contacting the sanitizing composition of the invention with the substrate at a temperature between 50 and 90° C. enhances reduction of the pathogen load on the substrate. In some embodiments, contacting the sanitizing composition of the invention with the substrate at a temperature between 50 and 90° C. enhances reduction of the pathogen load by at least 100%, at least 200%, at least 300%, at least 400%, at least 500%, at least 600%, at least 700%, at least 800%, at least 900%, at least 1000%, as compared to a method wherein contacting is at a temperature of less than 50° C.

In some embodiments, the effective amount of the sanitizing composition is such that at a contact time of one minute at a temperature of more than 10° C., more than 15° C., more than 20° C., more than 25° C., more than 30° C., more than 35° C., more than 40° C., the sanitizing composition results in reduction of colony forming units (CFU) of a pathogen on or within the substrate by a factor of 10 to 1,000,000 as compared to a non-treated substrate, wherein the pathogen is as described hereinabove.

In some embodiments, the method comprises contacting a substrate with an effective amount of the sanitizing composition for at least 30 seconds at a temperature of more than 10° C., more than 15° C., more than 20° C., more than 25° C., more than 30° C., more than 35° C., more than 40° C., more than 50° C., more than 60° C., thereby reducing pathogen load on the substrate by a factor of at least 10,000, of at least 100,000, of at least 1,000,000, including any value or arrange therebetween. In some embodiments, the method is for preventing pathogen growth on or within the substrate for at least 5 days (d), at least 10 d, at least 15 d, at least 20 d, at least 30 d, at least 40 d, at least 50 d, when stored at a temperature between 20 and 60° C. In some embodiments, the substrate is as described hereinbelow.

In some embodiments, the effective amount of the sanitizing composition is such that at a contact time of at least 30 seconds at a temperature of more than 10° C., more than 15° C., more than 20° C., more than 25° C., more than 30° C., more than 35° C., more than 40° C., more than 50° C., more than 60° C., the sanitizing composition results in reduction of CFU of a pathogen on or within the substrate by a factor of 10 to 1,000,000 as compared to a non-treated substrate, wherein the pathogen is as described hereinabove.

In some embodiments, the effective amount comprises the oxidizing agent at a w/w concentration within the sanitizing composition of at least 20 ppm, at least 30 ppm, at least 40 ppm, at least 50 ppm, at least 60 ppm, at least 70 ppm, at least 80 ppm, at least 90 ppm, at least 100 ppm, at least 120 ppm, at least 150 ppm, at least 200 ppm, at least 250 ppm, at least 300 ppm, including any range or value therebetween.

In some embodiments, the effective amount comprises the oxidizing agent at a w/w concentration within the sanitizing composition from 5ppm to 10,000 ppm, from 10 to 50 ppm, from 50 to 70 ppm, from 70 to 100 ppm, from 50 to 100 ppm, from 100 to 150 ppm, from 150 to 200 ppm, from 200 to 250 ppm, from 250 to 300 ppm, from 300 to 450 ppm, from 450 to 500 ppm, from 500 to 600 ppm, from 600 to 700 ppm, from 700 to 800 ppm, from 800 to 900 ppm, from 900 to 1000 ppm, from 1000 to 1500 ppm, from 1500 to 2000 ppm, from 2000 to 2500 ppm, from 2500 to 3000 ppm, from 3000 to 4000 ppm, from 4000 to 5000 ppm, from 5000 to 7000 ppm, from 7000 to 10,000 ppm, including any range or value therebetween.

In some embodiments, the effective amount comprises hydrogen peroxide at a w/w concentration within the sanitizing composition from 100 to 10,000 ppm, from 100 to 150 ppm, from 150 to 200 ppm, from 200 to 250 ppm, from 250 to 300 ppm, from 300 to 450 ppm, from 450 to 500 ppm, from 500 to 600 ppm, from 600 to 700 ppm, from 700 to 800 ppm, from 800 to 900 ppm, from 900 to 1000 ppm, from 1000 to 1500 ppm, from 1500 to 2000 ppm, from 2000 to 2500 ppm, from 2500 to 3000 ppm, from 3000 to 4000 ppm, from 4000 to 5000 ppm, from 5000 to 7000 ppm, from 7000 to 10,000 ppm, including any range or value therebetween.

In some embodiments, the effective amount comprises hydrogen peroxide at a w/w concentration within the sanitizing composition of at least 100 ppm, at least 120 ppm, at least 150 ppm, at least 200 ppm, at least 250 ppm, at least 300 ppm, including any range or value therebetween.

In some embodiments, the effective amount comprises a percarboxylic acid (e.g. perpropionic acid, and/or peracetic acid) at a w/w concentration within the sanitizing composition of at least 20 ppm, at least 30 ppm, at least 40 ppm, at least 50 ppm, at least 60 ppm, at least 70 ppm, at least 80 ppm, at least 90 ppm, at least 100 ppm, at least 120 ppm, at least 150 ppm, at least 200 ppm, at least 250 ppm, at least 300 ppm, including any range or value therebetween.

In some embodiments, the effective amount comprises propionic acid at a w/w concentration within the sanitizing composition of at least 50 ppm, at least 60 ppm, at least 70 ppm, at least 80 ppm, at least 90 ppm, at least 100 ppm, at least 120 ppm, at least 150 ppm, at least 200 ppm, at least 250 ppm, at least 300 ppm, at least 400 ppm, at least 500 ppm, including any range or value therebetween.

In some embodiments, the effective amount comprises any of citric acid and lactic acid at a w/w concentration within the sanitizing composition of at least 50 ppm, at least 60 ppm, at least 70 ppm, at least 80 ppm, at least 90 ppm, at least 100 ppm, at least 120 ppm, at least 150 ppm, at least 200 ppm, at least 250 ppm, at least 300 ppm, at least 400 ppm, at least 500 ppm, including any range or value therebetween.

In some embodiments, the ratio (e.g., molar ratio) of citric acid to lactic acid within the sanitizing composition is as described hereinabove.

In some embodiments, the molar ratio of any of the oxidizing agent (such as hydrogen peroxide) to total acid concentration within the sanitizing composition is at least 1:1, at least 1:1.2, at least 1:1.4, at least 1:1.6, at least 1:1.8, at least 1:2, at least 1:3, at least 1:4, at least 1:5, including any range or value therebetween. In some embodiments, the molar ratio of any of the oxidizing agent (such as hydrogen peroxide) to total acid concentration within the sanitizing composition is at most 5:1, at most 4:1, at most 3:1, at most 2:1 including any range or value therebetween.

In some embodiments, the effective amount comprises a molar ratio of the oxidizing agent to the propionic acid and the w/w concentration of the oxidizing agent and of the propionic acid sufficient to result in a formation of per-propionic acid at w/w concentration from 10 to 2000 ppm within the sanitizing composition.

In some embodiments, the method is for controlling pathogen load on the substrate surface. In some embodiments, the method is for reducing colony forming units (CFU) on the substrate and/or in the gas by a factor of 10 to 1,000,000, as compared to non-treated substrate surface.

As used herein, the terms “controlling” and “reducing” are used interchangeably and are related to reduction of colony forming unit (CFU)/cm² on the substrate surface, as compared to a non-treated substrate surface, by a factor of between 2 and 10, between 10 and 100, between 100 and 1000, between 1000 and 10,000, between 10,000 and 100,000, between 100,000 and 1,000,000, including any range between.

In some embodiments, the method is for reducing pathogenic activity on or within the substrate.

As used herein, the term “reducing pathogenic activity” refers to the ability to inhibit, prevent, reduce or retard bacterial growth, fungal growth, biofilm formation or eradication of living bacterial cells, or their spores, or fungal cells or viruses in a suspension, on or within the substrate, or in a moist environment, or any combination thereof. In some embodiments, inhibition or reduction or retardation of biofilm formation by a pathogen positively correlates with inhibition or reduction or retardation of growth of the pathogen and/or eradication of a portion or all of an existing population of pathogens.

In some embodiments, the method of the invention comprises reducing CFU/cm² on the substrate surface at least by a factor of 10, at least by a factor of 30, at least by a factor of 50, at least by a factor of 60, at least by a factor of 65, at least by a factor of 70, at least by a factor of 100, at least by a factor of 200, at least by a factor of 400, at least by a factor of 800, at least by a factor of 1000, at least by a factor of 10,000, at least by a factor of 100,000, at least by a factor of 1,000,000, as compared to a non-treated substrate surface.

In some embodiments, the method of the invention comprises reducing CFU on or within the substrate at least by a factor of 10, at least by a factor of 30, at least by a factor of 50, at least by a factor of 60, at least by a factor of 65, at least by a factor of 70, at least by a factor of 100, at least by a factor of 200, at least by a factor of 400, at least by a factor of 800, at least by a factor of 1000, at least by a factor of 10,000, at least by a factor of 100,000, at least by a factor of 1,000,000, as compared to a non-treated substrate surface.

In some embodiments, the method of the invention comprises inhibiting or eradicating pathogen load on or within the substrate, wherein inhibiting or eradicating comprise complete arrest of pathogen growth and/or complete eradication of the initial pathogen load.

Colonies start as single pathogen (CFU) which multiplies and forms a colony. Given enough CFUs close by, eventually, neighboring colonies will fuse. Increasing the magnification allows detection of micro-colonies before they fuse. In some embodiments, “colony” as used herein, refer to a colony observed by the naked eye. In some embodiments, “pathogen”, as used herein, refer to a microorganism such as bacteria and/or fungi.

In some embodiments, the method is for preventing or inhibiting pathogen load in or within the substrate. In some embodiments, the method is for preventing pathogen infection of the substrate at a storage temperature of above 25° C. during a time period of at least 3 d, 5 d, 10 days (d), at least 15 d, at least 12 d, at least 17 d, at least 20 d, at least 22 d, at least 25 d, at least 27 d, at least 30 d, at least 35 d, at least 40 d, including any range or value therebetween.

In some embodiments, the method is for preventing pathogen infection of the substrate at a storage temperature of below 15° C. during a time period of at least 1 month (m), at least 1 month (m), at least 2 m, at least 3 m, at least 4 m, at least 5 m, at least 6 m, at least 7 m, at least 8 m, at least 10 m, at least 12 m, including any range or value therebetween.

In another aspect of the invention, provided herein a method for prolonging or enhancing an anti-microbial effect of a sanitizing composition, comprising (i) providing a substrate treated by the sanitizing composition; (ii) contacting the substrate with a composition comprising (a) propionic acid, a salt thereof, or both, and (b) an acid component, wherein the acid component comprises at least one of an inorganic acid; a C1-C10 carboxylic acid or a salt thereof; thereby prolonging an effect of the sanitizing composition.

In some embodiments, the step (ii) of the method comprises contacting the substrate with a first composition of the kit of the invention. In some embodiments, the step (ii) of the method comprises contacting the substrate with the first composition of the kit or with a composition comprising propionic acid, citric acid and lactic acid at an amount sufficient for prolonging the effect of the sanitizing composition. In some embodiments, the first composition or the composition is as described hereinabove.

In some embodiments, the substrate is as described herein.

In some embodiments, the method of the invention as described hereinabove is for prolonging an anti-microbial effect of a sanitizing composition for a time period ranging from 1 to 40 days, including any range between, wherein prolonging is compared to the substrate which has not been treated by any of the compositions described herein. In some embodiments, the method is for selectively reducing fungal activity on or within the substrate, wherein reducing is as described hereinabove. In some embodiments, the method is for selectively reducing or preventing fungal activity. In some embodiments, the method is for selectively reducing or preventing fungal activity for a time period ranging from 1 to 40 days, as described below in the methods section.

In some embodiments, the method of the invention is for reducing edible matter decay. In some embodiments, edible matter decay comprises decay related to the pathogen load of the edible matter. In some embodiments, edible matter decay comprises decay related to common biological processes occurring within the harvested edible mater, such as dehydration, cell death, etc. As used herein, the term “reducing” comprises decay reduction of the edible matter treated by a sanitizing composition of the invention, as compared to a non-treated edible matter, wherein reduction is by a factor of between 2 and 10, between 10 and 100, between 100 and 1000, between 1000 and 10,000, including any range between.

In some embodiments, the method is for enhancing or prolonging storage stability and/or extending shelf life, relative to untreated edible matter. In some embodiments, enhancing or prolonging is by at least 20%, at least 50%, at least 100%, at least 200%, at least 500%, at least 1000%, including any range between.

In some embodiments, edible matter decay is selected from the group consisting of: loss from pathogen load, decomposing, sprouting, loss from a disease, rotting, dehydration, and blackheart formation, loss from a higher organism or any combination thereof.

In some embodiments, the sanitizing composition is applied at one or more stages in a life-cycle of the edible matter (such as seeding, foliage, flowering, post-harvest, pre-harvest etc.). In some embodiments, the sanitizing composition is applied to a harvested fruit and/or vegetable. In some embodiments, the sanitizing composition is applied to a processed fruit and/or vegetable, wherein processed comprises any food processing technique, such as cooking, slicing, etc.

In some embodiments, the substrate is selected for the group consisting of: an edible matter, soil, any growth medium, a propagation medium, a harvesting surface, a container, a storage surface, a transport surface, a packaging surface, a treatment surface, and a processing surface or any combination thereof.

In some embodiments, the method comprises contacting the composition with a substrate surface. Any surface can be treated by the composition of the invention (also referred to as “disinfectant”).

In some embodiments, the substrate is an interior surface of a container.

Examples of substrates that may be treated by the disinfectant include, but are not limited to: food processing equipment surfaces such as tanks, conveyors, floors, drains, equipment surfaces, walls, valves, belts, pipes, joints, crevasses, or any combination thereof.

The substrate can be metal, for example, aluminum, steel, stainless steel, chrome, titanium, iron, alloys thereof, and the like. The surfaces can also be plastic, for example, polyolefins (e.g., polyethylene, polypropylene, polystyrene, poly(meth)acrylate, acrylonitrile, butadiene, ABS, acrylonitrile butadiene, etc.), polyester (e.g., polyethylene terephthalate, etc.), and polyamide (e.g., nylon), combinations thereof, and the like. The surfaces may also be brick, tile, ceramic, porcelain, wood, vinyl, linoleum, or carpet, combinations thereof, and the like.

In some embodiments, the substrate is the exterior surface of the edible matter.

In some embodiments, the edible matter is selected from the group consisting of fruits, vegetables, grains, sprouts, nuts, seeds, meats, meat products, milk, milk products, fish, poultry, eggs, and mixtures thereof.

Non-limiting example of edible matter include but are not limited to: apple, avocado, citrus (e.g. clementine, orange, grapefruit, lemon), date, kiwi, lychee, mango, peach, pear, persimmon, pomegranate, pepper, asparagus, banana, broccoli, cabbage, carrot, cauliflower, celery, corn, kohlrabi, cucumber, eggplant, garlic, lettuce, onion, peanut, potato, strawberry, sweet pepper, sweet potato, tomato, watermelon, and grape or any combination thereof.

In some embodiments, the method comprises contacting the substrate with the composition of the invention, wherein the composition is in a liquid state, in a gaseous state, or in a form of an aerosol, including any combination thereof.

In some embodiments, the method comprises contacting the substrate with the composition of the invention, wherein contacting is selected from the group consisting of: spraying, submerging, dipping, and injecting or any combination thereof.

In some embodiments, contacting is by spraying the composition into the interior (e.g. ambient gas) of a container. In some embodiments, contacting is by fogging.

Fogging is a process by which a liquid composition (e.g. disinfectants) are aerosolized. The aerosol and/or fogging particles (micro droplets at a size of 0.1-10 micron) of the disinfectant are suspended within the ambient gas (e.g. air) for a period of time in order to disinfect both the air itself and surfaces, including inaccessible parts of a substrate.

Non-limiting example of pathogens include but are not limited to: cryophiles, nematodes, mites, ticks, fungi, algae, mold, bacteria, viruses, spores, yeast, and bacteriophages or any combination thereof.

In some embodiments, the pathogen is selected from the group consisting of: bacteria, a fungus, a yeast, a virus, an algae, a mold, protozoa, an amoeba, and spore-propagating microorganisms or any combination thereof.

In some embodiments, bacteria are selected from the group consisting of gram-positive bacteria. In some embodiments, the gram-positive bacteria are selected from the group consisting of Staphylococcus, Streptococcus, Enterococcus, Bacillus, Corynebacterium, Nocardia, Clostridium, Actinobacteria and Listeria or any combination thereof.

In some embodiments, bacteria are selected from the group consisting of gram-negative bacteria. In some embodiments, the gram-negative bacteria are selected from the group consisting of Escherichia, Salmonella, Shigella, Enterobacteriaceae, Pseudomonas, Moraxella, Helicobacter, Stenotrophomonas, Bdellovibrio, acetic acid bacteria, Legionella, cyanobacteria, spirochaetes, green sulfur bacteria, green non-sulfur bacteria, and respiratory symptoms Moraxella or any combination thereof.

In some embodiments, bacteria are selected from the group consisting of Escherichia coli, Staphylococcus aureus, Pseudomonas aeruginosa and Enterococcus hirae or any combination thereof.

In some embodiments, the fungus is selected from the group consisting of Magnaporthe, Ophiostoma, Cryphonectria, Fusarium, Ustilago, Alternaria, Cochliobolus, Aspergillus, Candida, Cryptococcus, Histoplasma, and Pneumocytis or any combination thereof.

In some embodiments, the yeast is selected from the group consisting of Cryptococcus neoformans, Candida albicans, Candida tropicalis, Candida stellatoidea, Candida glabrata, Candida krusei, Candida parapsilosis, Candida guilliermondii, Candida viswanathii, Candida lusitaniae and Rhodotorula mucilaginosa or any combination thereof.

In some embodiments, the virus is selected from the group consisting of Adenoviruses, Herpesviruses, Poxviruses, Parvoviruses, Reoviruses, Picornaviruses, Togaviruses, Orthomyxoviruses, Rhabdoviruses, Retroviruses and Hepadnaviruses or any combination thereof.

In some embodiments, the method is for preventing biofilm formation on the substrate. In some embodiments, the method is for inhibiting biofilm formation. In some embodiments, the method is for reducing existing biofilms. In some embodiments, the method is for breaking-down existing biofilms.

As used herein the term “biofilm” refers to any three-dimensional, matrix-encased microbial community displaying multicellular characteristics. Accordingly, as used herein, the term biofilm includes surface-associated biofilms. Biofilms may comprise a single microbial species or may be mixed species complexes, and may include bacteria, or other microorganisms.

In some embodiments, the biofilm is essentially nullified or is reduced by at least 20% , at least 30%, at least 40%, at least 50%, at least 60%, at least 70%, at least 80%, at least 90%, including any value therebetween. Unless otherwise indicated, the word “or” in the specification and claims is considered to be the inclusive “or” rather than the exclusive or, and indicates at least one of, or any combination of items it conjoins.

It should be understood that the terms “a” and “an” as used above and elsewhere herein refer to “one or more” of the enumerated components. It will be clear to one of ordinary skill in the art that the use of the singular includes the plural unless specifically stated otherwise. Therefore, the terms “a”, “an” and “at least one” are used interchangeably in this application.

For purposes of better understanding the present teachings and in no way limiting the scope of the teachings, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained. At the very least, each numerical parameter should at least be construed in light of the number of reported significant digits and by applying ordinary rounding techniques.

In the description and claims of the present application, each of the verbs, “comprise”, “include” and “have” and conjugates thereof, are used to indicate that the object or objects of the verb are not necessarily a complete listing of components, elements or parts of the subject or subjects of the verb.

Other terms as used herein are meant to be defined by their well-known meanings in the art.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

### EXAMPLE 1

### Stability of the Acid Blend and of the Exemplary Sanitizing Composition

In order to test the stability of an exemplary acid blend, an aqueous solution containing a mixture of propionic acid, lactic, acid and citric acid was prepared. A final concentration of each acid within the solution was 20% w/w. Furthermore, a stability of a composition containing the abovementioned acid blend together with 5% w/w hydrogen peroxide was tested. The stability of the composition and of the acid blend was analyzed by C-NMR.

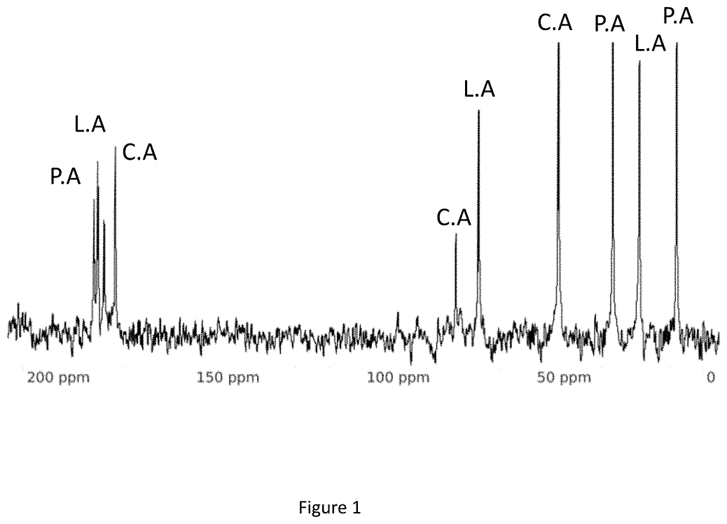

As represented by FIG. 1, no decomposition of the components of the acid blend was observed after 48 h storage.

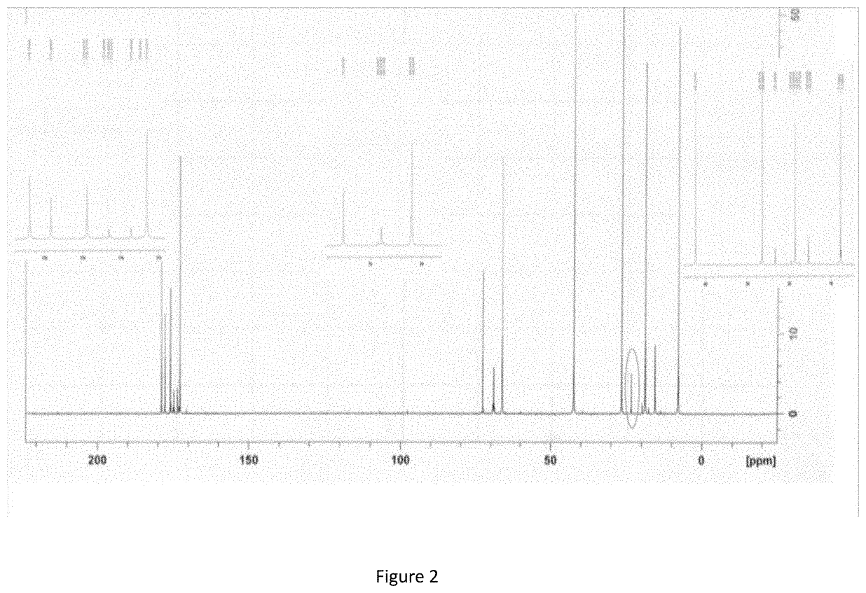

After 48 h storage of the composition composed of the acid blend and hydrogen peroxide, new peaks were detectable by 13C-NMR corresponding to perpropionic acid (23.4 ppm) and acetic acid (19.6 ppm), as shown by FIG. 2. The formation of acetic acid may be indicative of the oxidation of lactic acid to pyruvic acid (176.0, 97.5, 17.5, 13.5 ppm) and subsequent decarboxylation to acetic acid (19.8±0.2 ppm). These results indicate that the composition containing the acid blend and hydrogen peroxide is characterized by a limited storage stability. Accordingly, it is preferable using the kit of the invention for the manufacturing of the sanitizing composition of the invention. Furthermore, by implementing the kit described herein, a precise dosing of any of the active ingredients can be achieved. This is specifically important for the treatment of fruits and/or vegetables requiring a tailored ratio between the total acid content to the oxidizing agent, as predetermined either by the pH of the fruit and/or vegetable (see Example 4); or by the regulation in each particular country.

### EXAMPLE 2

Inoculum preparation: Infected lemons were identified visually and collected under three different lemon trees on Moshav Beit Yitzhak. Ten of the more infected lemons were put into a food processor, diluted with rainwater and homogenized to uniform, grayish brown, slightly viscous liquid consistency.

All lemons used in the trails were purchased from Mehadrin Pro-Or Ashkelon packing house ensuring that they did not undergo any cleaning or sanitizing treatments in the packing house. They were sent to de-greening from which they were removed on 2^{nd} day. All lemons were pricked in 6 different location on each lemon using a metal nail attached to a rubber stopper which ensured a uniform pricking depth of 1.5 mm on all the lemons. On the same day the liquidized inoculum was prepared as described above and all the lemons were dipped into the “infected” water solution for 30 seconds and allowed to dry at ambient room conditions—temperatures between 11-9° C.

On the next day the lemons were treated as per description below to screen the various treatment's efficacy in controlling and preventing decay and spoilage of the pre-infected lemons. All treated lemons were divided and placed in separate cartons and allowed to dry. Disease progress of the lemons was monitored for 7 days with no visible disease symptoms. On day 8 after treatment all cartons were covered with plastic sheeting in order to increase ambient humidity to speed up disease development.

TABLE 1
Number of infected/uninfected lemons 10 & 15 days after treatment

| | | Contact | Infected | % Infected | Infected | % Infected |
|---|---|---|---|---|---|---|
| Treatment | | Time | Lemons | lemons | Lemons | Lemons |
| Nr. | Treatment | (sec) | 10 DAT | | 15 DAT | |
| 1 | Untreated Control | — | 4 | 40 | 4 | 40 |
| 2 | Tap water wash | 60 | 7 | 70 | 7 | 70 |
| 3 | PAA 50 ppm/PAA 50 ppm | 60 | 0 | 0 | 2 | 16.7 |
| 4 | PAA 50 ppm/PAA 50 ppm | 45 | 3 | 20 | 3 | 25 |
| 5 | PAA 30 ppm | 45 | 4 | 40 | 4 | 40 |
| 6 | SF3HS 50 ppm | 45 | 4 | 40 | 5 | 50 |
| 7 | PAA 30 ppm + SF3 1:1000/ | 45 | 1 | 7.15 | 1 | 7.15 |
| | PAA 50 ppm + SF3 1:1000 | | | | | |
| 8 | PAA 30 ppm + SF3 1:1000/ | 60 | 0 | 0 | 0 | 0 |
| | PAA 50 ppm + SF3 1:1000 | | | | | |
| 9 | SF3HS 1:2000/SF3H 1:2000 | 45 | 1 | 7.15 | 2 | 15.38 |
| 10 | SF3HS 1:2000/SF3H 1:2000 | 60 | 1 | 7.15 | 1 | 7.15 |
| 11 | SF3HS 1:1000/SF3H 1:1000 | 45 | 0 | 0 | 0 | 0 |
| 12 | SF3HS 1:1000/SF3H 1:1000 | 60 | 0 | 0 | 0 | 0 |

SF3H and SF3HS are exemplary sanitizing compositions comprising the acid blend (propionic acid, lactic acid, citric acid) and hydrogen peroxide, wherein the concentration of each of propionic acid, lactic acid, citric acid and hydrogen peroxide within the composition was about 10% w/w. PAA refers to per-acetic acid.

An exemplary first component of the kit of the invention comprises propionic acid, lactic acid, and citric acid, wherein each of the acid is at a w/w concentration of between 10 and 25%, and further comprising between 20 and 25% w/w of water. Optionally, the first component of the kit of the invention further comprises between 0.1 and 1%w/w of a surfactant wherein the surfactant is as described herein.

### EXAMPLE 3

The antimicrobial activity of the composition was tested in-vitro. The edible matter contaminated with bacteria (Listeria) was dipped into a test solution containing various concentrations of the acid blend consisting of propionic acid, lactic acid, and citric acid at 1:1:1 molar ratio together with various concentrations of an oxidizing agent. The contact time was 60 minutes. The antimicrobial activity was assessed by calculating bacterial viability (e.g. reduction of the CFU). Compositions causing at least 10⁵-fold reduction of CFUs were considered as potent.

The experimental results evidenced that a 100 ppm of propionic acid within the abovementioned solution is sufficient for antibacterial activity. In addition, a minimum concentration of hydrogen peroxide within the solution was 200 ppm. Neither hydrogen peroxide, nor silver/hydrogen peroxide combination showed a significant antimicrobial activity.

### EXAMPLE 4

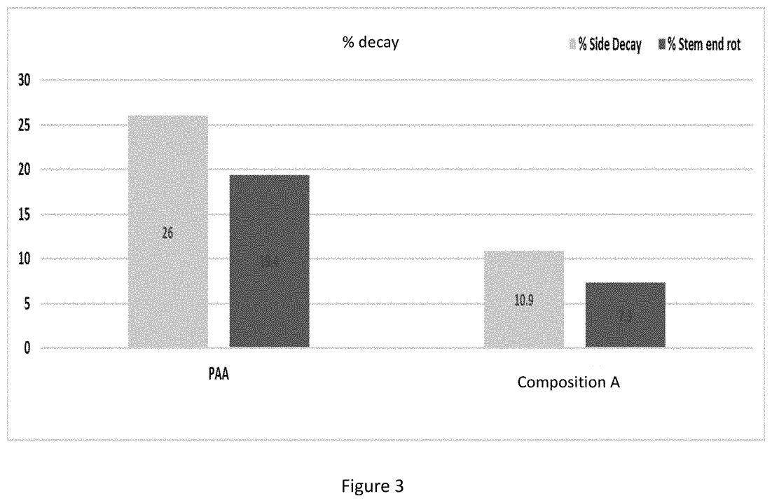

The inventors performed several experiments, to evaluate the effectiveness of exemplary sanitizing compositions in preventing decay of harvested fruits and/or vegetables. Exemplary sanitizing composition (Composition A) was applied on mangos, and the fruit decay was evaluated as compared to only PAA treatment. Mangos were stored for three weeks after treatment at 12° C. and an additional week of shelf life at 20° C. The results are represented in FIG. 3.

As represented by FIG. 3, treatment with an exemplary sanitizing composition resulted in a superior biocide activity over treatment by PAA alone. Treatment with an exemplary sanitizing composition resulted in a reduction in both side decay and stem-end rot (common pathogens in mango) leading to an extended shelf life.

Composition A: an aqueous solution containing between 3000 and 5000 ppm of total acid content (almost equal w/w ratios of propionic acid, lactic acid, and citric acid of between 1000 and 1700 ppm of each acid and between 80 and 150 ppm of PAA (as the oxidizer).

Additionally, exemplary sanitizing composition (Composition B) was applied on clementine, and the fruit decay was evaluated as compared to only PAA treatment or untreated fruits. The fruits were infested with a common fungal pathogen at a concentration of around 105 CFU and inoculated for 16-24 hours before treatment. Following the treatments, the fruits were stored in cold storage for between 9 to 21 days and then stored in room temperature for shelf-life evaluation.

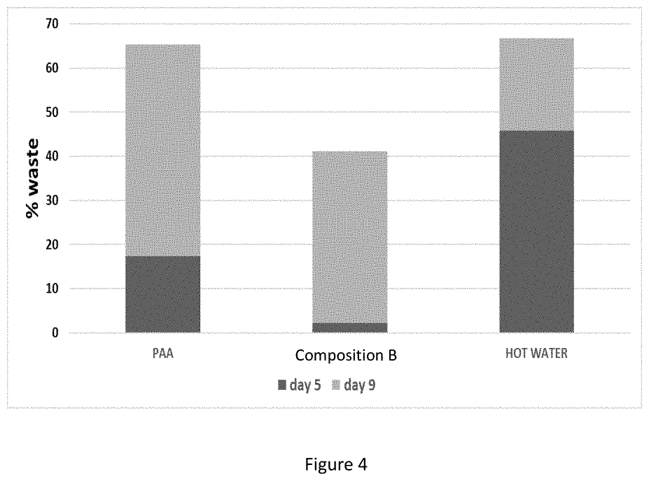

As represented in FIG. 4, the results of the trials have shown that the exemplary sanitizing composition (Composition B) resulted in a superior biocide activity (almost complete decay reduction) over treatment by PAA alone (resulting in about 20% decay), while improving the fruit shelf life, thus reducing waste.

Composition B: an aqueous solution containing between 200 and 400 ppm of total acid content (almost equal w/w ratios of propionic acid, lactic acid, and citric acid of between 70 and 130ppm of each acid) and between 80 and 150 ppm of PAA (as the oxidizer).

Additionally, exemplary sanitizing composition (Composition C) was applied on harvested bell peppers, and the fruit decay was evaluated as compared to only chlorine treatment (between 80 and 150 ppm of aqueous hypochlorite solution). Bell papers were stored for 23 days after treatment at 7° C. and an additional 5 days of shelf life at 20° C.

The results of the trials have shown that Composition C significantly reduced (by between 2 times and 5 times) (i) decay, and (ii) pathogen load of the tested peppers. Furthermore, Composition C improved quality (firmness) by about 40%, compared with chlorine treated peppers. The observed pathogen related decay of the peppers treated by the exemplary sanitizing composition, as described herein, was of about 1%, compared to between 2 and 7% decay of peppers which underwent chlorine treatment.

To this end, it has been exemplified that the combination of the acids of the invention is essential for prolonging shelf life of the edible matter. Microbial growth can be limited inter alia by lowering the pH of the edible matter, by utilizing the sanitizing compositions of the invention. The approximate ranges of pH values on the outer surface of common fresh and processed foods will determine the efficient concentration of acids applied thereto. For example, avocado and mango have a pH >5.5, and require greater amounts of total acids, whereas lime and apples have a pH on<4, so that the sanitizing composition applied to lime and/or apples require lower total acids amount, as exemplified hereinabove.

More important than the external pH is the pH within the micro-organism cell, the cytoplasm pH of the microbial cell. It is postulated, that strong acids which are dissociated in H+ and anion do not pass the phospholipid cell membrane easily. However, weak acids such as propionic, benzoic and sorbic are lipid soluble and enter through the cell membrane into the cytoplasm by simple diffusion of the undissociated acid.

The pH of the cytoplasm is close to neutral, which means that inside the cell the weak acid will dissociate into H+ and anion. The anions will accumulate in the cell and the H+ protons will absorb the buffering capacity and eventually the combined effect of a low pH plus a high weak-acid concentration leads to acidification of the cytoplasm, which is usually sufficient to restrict microbial growth, decrease the cytoplasm pH, which results in bacteriostatic or bacteriocidal effects. Essential for the weak acid effect is the presence of undissociated weak acid in the external medium, meaning that the external pH of the food is preferably below the pKa value of the preservative.

Therefore, when propionic acid is used at a lower pH then it's pKa (4.87) more of the propionic acid to be in the undissociated acid form making it more effective with enabling the use of low concentrations that don't affect the taste.

The sanitizing composition comprising a combination of oxidizing agent (preferably PAA and/or hydrogen peroxide), propionic and an acid with pKa<4.75, has a synergistic effect compared to each individual ingredient. The sanitizing composition reduces the pathogen load and prolongs shelf life of the edible matter, by implementing lower concentration than each ingredient alone. In addition sanitizing composition provides a more stable per-acid.

The sanitizing compositions disclosed herein, are non-toxic and safe providing a long-lasting protection to the treated produce. All the ingredients used for the preparation of the sanitizing compositions of the invention are recognized by the FDA as Generally Recognized as Safe (the “GRAS”).

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

1. A sanitizing composition comprising an effective amount of (i) an oxidizing agent, of (ii) propionic acid, a salt thereof, or both, and of (iii) an acid component, the acid component comprises at least one of:
an inorganic acid a salt thereof, or both;
a C0-C10 carboxylic acid, a salt thereof, or both; and
wherein said effective amount is so as to result in a w/w concentration of peroxypropionic acid within said composition of at least 10 ppm, and wherein a pH of said composition is between 0 and 5.5.

2. The sanitizing composition of claim 1, wherein said inorganic acid is selected from the group consisting of phosphorous acid, phosphoric acid, hydrochloric acid, sulfuric acid, nitric acid, a salt thereof, a cation exchanging resin or a combination thereof; and wherein said oxidizing agent is selected from the group consisting of: a percarboxylic acid (PA), hydrogen peroxide, urea hydrogen peroxide, sodium peroxide, calcium peroxide, silver, silver salt and hydrogen peroxide (HP), sodium percarbonate, sodium periodate, sodium persulfate, ammonium persulfate, perchloric acid, sodium perborate, silver (II) oxide, chlorine dioxide, benzoyl peroxide, a ketone peroxide, a peroxydicarbonate, a peroxyester, a dialkyl peroxide, a hydroperoxide, and a peroxyketal or any combination or salt thereof.

3. The sanitizing composition of claim 1, wherein a w/w concentration of said propionic acid, said salt thereof, or both within said sanitizing composition is at least 50ppm.

4. The sanitizing composition of claim 1, wherein said effective amount comprises a total w/w concentration of (i) said propionic acid, said salt thereof, or both; and of (ii) said acid component within said sanitizing composition is between 250 and 4000 ppm.

5. (canceled)

6. The sanitizing composition of claim 1, wherein said C0-C10 carboxylic acid comprises a plurality of C0-C10 carboxylic acids optionally wherein each C0-C10 carboxylic acid independently comprises a C1-C6 carboxylic acid.

7. (canceled)

8. The sanitizing composition of claim wherein said C1-C6 carboxylic acid is selected from the group consisting of: lactic acid, citric acid, glycolic acid, butanoic acid, tartaric acid, and acetic acid, or any combination thereof.

9. The sanitizing composition of claim 1, wherein said sanitizing composition further comprises an agent selected from the group consisting of: a carrier gas, an aqueous solvent, a surfactant, an additive, and a stabilizer or any combination thereof, optionally wherein the w/w concentration of: a) said surfactant and b) said stabilizer within said sanitizing composition is in a range from 0.1 to 10%; and wherein said additive comprises any one of a base, a pH regulator, an organic additive, or any combination thereof.

10. The sanitizing composition of claim 9, wherein said surfactant is selected from the group consisting of: a non-ionic surfactant, an anionic surfactant, a cationic surfactant and an amphoteric surfactant or any combination thereof.

11. (canceled)

12. (canceled)

13. The sanitizing composition of claim 1, wherein said oxidizing agent comprises HP, PA or both.

14. The sanitizing composition of claim 1, wherein said effective amount comprises a w/w concentration of said oxidizing agent of between 300 ppm and 1%.

15. The sanitizing composition of claim 1, wherein said sanitizing composition is stable for at least 48 h.

16. A method for reducing pathogen load, the method comprising:
i. providing a substrate; and
ii. contacting said substrate with an effective amount of the sanitizing composition of claim 1 under conditions sufficient for reducing pathogen load on or within said substrate; wherein said substrate is selected for the group consisting of: an edible matter, a growth medium, a propagation medium, a harvesting surface, a container, a storage surface, a transport surface, a packaging surface, a treatment surface, and a processing surface or any combination thereof; wherein said method is for reducing colony forming units (CFU) of said pathogen on said substrate by a factor of 10 to 100,000, as compared to a non-treated substrate.

17. (canceled)

18. The method of claim 16, wherein said contacting is selected from the group consisting of: spraying, submerging, dipping, and injecting or any combination thereof, wherein said contacting is for a time sufficient for reducing said pathogen load on or within the substrate.

19. (canceled)

20. (canceled)

21. The method of claim 16, wherein said method is for preventing or inhibiting pathogen formation on said substrate within a time period of at least 5 days; (ii) reducing decay of said edible matter, or both (i) and (ii).

22. (canceled)

23. (canceled)

24. (canceled)

25. (canceled)

26. A kit comprising a first composition comprising (i) propionic acid, a salt thereof, or both, and (ii) an acid component, wherein said acid component comprises at least one of:
a. an inorganic acid a salt thereof, or both;
b. a C0-C10 carboxylic acid, a salt thereof, or both;
and wherein a combined weight per weight (w/w) concentration of (i) and (ii) within said first component is between 20 and 90%.

27. The kit of claim 26, further comprising a second component comprising an oxidizing agent.

28. The kit of claim 27, wherein said oxidizing agent is selected from the group consisting of: a percarboxylic acid, hydrogen peroxide, urea hydrogen peroxide, sodium peroxide, calcium peroxide, silver, sodium percarbonate, sodium periodate, sodium persulfate, ammonium persulfate, perchloric acid, sodium perborate, silver (II) oxide, chlorine dioxide, benzoyl peroxide, a ketone peroxide, a peroxydicarbonate, a peroxyester, a dialkyl peroxide, a hydroperoxide, and a peroxyketal or any combination or salt thereof.

29. The kit of claim 26, wherein a w/w concertation of said oxidizing agent within said second component is between 5 and 90%; and wherein said (i) propionic acid, said salt thereof, or both; and said (ii) acid component are present within said first component at a synergistically effective ratio between (ii) and (i) of at least 1:1 w/w; wherein said acid component comprises citric acid, lactic acid or both; and wherein said first component, said second component, or both is stable for at least 6 months.

30. (canceled)

31. (canceled)

32. The kit of claim 26, wherein said first component, said second component, or both further comprise an agent selected from the group consisting of: a surfactant, an additive, a solvent, and a stabilizer or any combination thereof; and wherein said kit further comprises instructions for mixing of said first component and of said second component at a predetermined ratio, thereby obtaining a sanitizing composition comprising a sanitizing effective amount of (i) said propionic acid, said salt thereof, or both; (ii) said acid component and (iii) said oxidizing agent.

33. (canceled)

34. (canceled)

35. The kit of claim 26, wherein said sanitizing effective amount comprises a w/w concertation of said propionic acid, a salt thereof, or both of between 50 ppm and 0.5%; and wherein said sanitizing effective amount comprises a w/w concertation of said oxidizing agent is between 10 and 1000 ppm; wherein any one of said first component and said second component is a liquid, and wherein said sanitizing composition is characterized by a pH of less than 5.

36. (canceled)

37. (canceled)
